(19) United States
(12) Patent Application Publication
(10) Pub. No.: US 2006/0173720 A1
(43) Pub. Date: Aug. 3, 2006

(54) Methods and apparatus for securitizing insurance, reinsurance, and retrocessional risk

(76) Inventors: Mark H. Berens, Northbrook, IL (US); Jerome A. Harris, Glenview, IL (US); David N. Thompson, Chicago, IL (US)

Correspondence Address: James F. Goedken;Bell, Boyd & Lloyd LLC, P.O. Box 1135, Chicago, IL, 60690-1135, US

(21) Appl. No.: 11/049,326

(22) Filed: Feb. 1, 2005

(51) Int. Cl. G06Q 40/00

(52) U.S. Cl. 705/4; 705/38

(57) ABSTRACT

A method and apparatus of securitizing insurance, reinsurance and retrocession risk is provided. The system provides a vehicle whereby investors may directly participate in such risk. The system includes establishing a limited-life business entity. Capital is raised through the sale of common and/or preferred shares in the business entity. The capital is invested against which the business entity assumes premium and risk liability. After a first predetermined period of time (i.e., an underwriting phase), the business entity stops underwriting risks for premium and gives investors options to liquidate shares in the business entity for cash or in the form of a roll over to a similar business entity. The business entity then runs off remaining risk liabilities during a second predetermined period of time (i.e., a runoff phase). Upon completion of the runoff phase, the business entity distributes all its remaining assets to its shareholders and/or rolls over their equity to another similar business entity, and the original business entity is wound up.

### TECHNICAL FIELD

The present system relates to methods and apparatus for securitizing insurance, reinsurance and retrocessional risk, and providing an equity security for investors to participate in such risk.

### BACKGROUND

Insurance and Reinsurance Market. The primary insurance market provides financial protection against numerous types of risk. In exchange for insurance premium, an insurer agrees to underwrite the risks specified in the insurance policy. If the event insured against occurs, the insurer is obligated to pay for all or a portion of the financial loss incurred by the policyholder.

There are many types of insurance covering many kinds of risks, broadly divided into (i) life and health; (ii) property and casualty; and (iii) surety and guaranty. Policies may insure individuals, groups, businesses, and governments, generally for a one-year period, but sometimes for shorter or longer periods. Insurance had its beginnings at the time of Hammurabi. It has developed with civilization to address the needs of society, but its broad contours have not changed substantially since Lloyds of London was formed over 300 years ago. The system offered is a new method for conducting and financing insurance and reinsurance operations, that attracts a broader base of investors to participate in risk and reward.

Property and Casualty. Property and casualty is subdivided into personal and commercial lines. Fire insurance protects against the risk of damage to property from fire and allied risks. Homeowners and renters insurance add a broad package of risks to basic fire protection. Auto insurance protects against both damage to property (collision and comprehensive) and injury to third parties (liability). Professional errors and omissions (malpractice) insurance protects against liability arising from negligent professional services, especially legal, accounting and medical. Officer and director insurance protects the insureds from mismanagement or breach of fiduciary duty. Bankers' blanket bond protect financial institutions from a variety of theft and fraud risks. Risks of transportation are covered by marine and inland marine policies. These are but a sampling of the numerous types of insurance and the variety of risks insured.

Most casualty and property policies are “occurrence” policies, which insure against an event such as a fire or a collision. Occurrence of the event triggers the insurance coverage. In contrast, malpractice and director and officer policies usually are “claims made,” policies where coverage is triggered when a claim against the insured is asserted.

When an insured purchases insurance to protect against a specified property or casualty risk, the risk remains, but the financial exposure from the risk is transferred in whole or part to the insurer. By writing insurance contracts, the insurer accepts premium and assumes risk liability. Fortunately, not all insured risks occur. Most buildings do not burn. Most professionals do not commit malpractice. By selective underwriting and realistic premium pricing, an insurer can reasonably expect that the aggregate amount of premium received will exceed the total amount that must be paid for losses, defense of insureds, and operating expenses. If premium received exceeds those costs, the insurer realizes an underwriting profit, and conversely, an underwriting loss if the premium received is less than those costs.

Upon entering into insurance contracts, the insurer must be able to pay incurred losses. Since it is impossible to predict when losses will occur, or their frequency and their severity, the insurer must have adequate financial resources to pay claims as losses occur. The insurer's net worth (capital and surplus), loss reserves and premiums collected, provide these resources. These funds are invested, and the investment earnings increase the resources available to the insurer.

An insurer's or reinsurer's capacity to underwrite risks directly depends on its net worth. The risk-based capital rules adopted by all States in general have the effect of limiting the amount of premium from 1 to 3 times net worth, primarily based on the volatility or unpredictability of different categories of risk. For example, more predictable personal lines may be underwritten at a ratio of 4 to 1 of premium-to-net worth while volatile malpractice risks may be limited to 1 to 1.

In contrast, professional liability insurance and environmental contamination insurance are “long tail” risks. Such liability often cannot be determined for years, even decades after the events that eventually result in an insurance claim. With environmental contamination, for example, it may take years for spilled toxins to seep into the local ground water and pollute wells remote from the original contamination site. It may take even longer to determine the source of the toxins and still longer to determine who was responsible for their presence. Only then can the cost of cleaning up the problem be estimated. Thus, an insurer who insures against such risk is potentially exposed to liability for an extended period of time, and the amount of loss is highly variable. In general, short tail risk is less volatile than long tail risk, making it much easier to estimate losses in order to establish realistic premium rates.

Life and Health. Life underwriting involves an array of life policies—term, ordinary life, universal life, endowments—and annuity contracts. Many life companies (and some casualty companies) underwrite both individual and group health coverages—medical, hospital, prescription, accidental death and dismemberment, long-term disability and long-term care.

Surety and Guaranty. These coverages include bonding, such as surety and fidelity; performance guaranties such as for construction or government contracts; and financial guaranties, such as for mortgages.

Reinsurance. The fundamental principle of insurance is the transfer of risk. For a premium, financial risk is transferred from the insured to the insurer. Even though premium rates are set to produce an underwriting profit, this may not occur if there are more claims than expected (“frequency risk”) or if claims are larger than projected (“severity risk”).

All categories of insurance risk—property and casualty, life and health, and surety and guaranty—can be passed off and spread. Protection against primary insurance risk is known as reinsurance. Primary insurers transfer a portion of their risk to reinsurers through contracts called reinsurance “treaties” (in contrast to primary insurance contracts called “policies”). In a typical reinsurance treaty the primary insurer cedes a percentage of its received premium, together with a corresponding portion of its outstanding risk, to one or more reinsurers. The primary insurer who cedes risk and premium is known as the ceding company, and the party that assumes the risk is known as the reinsurer or cedant. The further transfer of risk by a reinsurer to another reinsurer is known as a retrocession. Most treaties are for one year, but there are 2- and 3-year treaties and some longer terms.

Reinsurance treaties can transfer risk in many ways. For example, in a “whole account” reinsurance treaty the insurer cedes a portion of its risk from all of its lines of business, e.g., auto, homeowners, professional liability, directors and officers, and others. Alternatively, a reinsurance treaty may be limited to a single line, such as standard auto, or a group of related coverages.

Reinsurance treaties also may be distinguished by the manner in which the primary insurer's risk is ceded. Quota share reinsurance protects against the risk that a primary insurer will incur excessive aggregate loss—whether caused by frequency or a combination of frequency and severity—in its overall book of business (whole account) or in a particular line. By such treaties, the primary insurer cedes a specific percentage of its received premium with the related risk—e.g., 20% of its received premium and 20% of the outstanding risk being reinsured. However, the assuming reinsurers typically will accept less than the aforementioned 20% to compensate the ceding insurer for the cost of generating and underwriting the business. This allowance is known as a ceding commission. Quota share treaties may be capped. For example, a reinsurer may agree to pay 20% of all claims ceded to it up to an aggregate limit of $25 million for all claims. The coverage may be limited to a layer of risk—e.g., 20% of all losses up to $2 million per claim.

Excess-of-loss reinsurance primarily protects against severity—e.g., large individual claims. In an excess-of-loss treaty the ceding company cedes a percentage of risk above a defined threshold, such as $10 million, known as the ceding company's retention, or a defined layer such as between $10 and $25 million ($25 m excess of $10 m). For an agreed premium, the reinsurer agrees to pay a portion of any loss incurred by the insurer in excess of the ceding company's retention or within the defined layer. If the loss exceeds the upper limits of the coverage, the excess risk reverts to the ceding company or is covered by a higher excess-of-loss layer purchased by the ceding company. Ceding companies typically purchase excess-of-loss reinsurance in multiple layers to protect against extremely large claims. An excess-of-loss treaty may be subject to an aggregate limit or cap.

There are numerous other variations in quota share and excess-of-loss treaties, including commutation options, whereby the ceding company has the option to cancel the treaty and receive a partial refund of premium paid according to a pre-agreed formula; and numerous forms of profit sharing and retrorating whereby the premium is increased or decreased according to loss results. Although quota share and excess-of-loss are the most common type of reinsurance treaties, there are many other types.

Because the development of risk is unpredictable, primary insurers often enter into a web of different types of reinsurance treaties to protect against many loss scenarios, as is illustrated by FIG. 1, which depicts a conventional reinsurance structure of a malpractice insurance facility for large law firms. This is an example of both frequency and severity exposures from long tail liabilities in contrast to the more predictable short tail exposures illustrated by FIGS. 3 thru 29.

The chart in FIG. 1 is divided both horizontally and vertically. From the bottom up, the horizontal layers show the division of risk for a single claim among the insureds: the primary insurer; the first tier reinsurer, which is the insurer's parent; and commercial market retrocessionaires. The vertical divisions show as the claim amount increase, the allocation of risk, at each layer, retained by the primary insurer, its parent reinsurer, and the further distribution of the remaining risk between the U.S. and European retrocessionaires. More than 60 reinsurers participated in this long tail and volatile risk.

The bottom layer 12 represents the retentions available to the insured large law firms—e.g., $100,000 to $1,000,000 of each claim made against the firm. The higher the retention, the lower the premium for the insurance.

The next layer 14 shows a $100,000 per claim retention by the primary insurer.

The remaining layers, in ascending order, show 16 a quota share layer and four layers 18, 20, 22, and 24 of excess-of-loss treaties, providing an overall limit of $75 million per claim in excess of the insured's retention. For a full $75 million loss in excess of the insured retention, the primary insurer will be liable for $100,000; its reinsuring parent will be liable for $10,249,000; the quota share reinsurers $2,523,500; and the excess-of-loss reinsurers $62,127,500.

Reinsurers may be “direct markets” with which the ceding company negotiates directly. Other reinsurers are “broker markets” which deal exclusively with licensed reinsurance brokers. In this situation, the ceding company and its broker design a reinsurance program, which the broker then attempts to place, depending on the size of the risk, with a single, a few, or many reinsurers.

Inasmuch as brokers are paid commission based on performance, it is in their interest to place treaties as quickly and efficiently as possible. Accordingly, brokers will concentrate their efforts on reinsurers having known willingness and the financial capacity to take on the risk, especially if it involves a large amount of coverage. For a reinsurer, it is highly valuable to see considerable broker traffic attempting to place reinsurance. If a large number of brokers are offering many different treaties, the reinsurer can be more selective as to the type and quality of the risk it is willing to assume.

Reinsurance Leverage. Reinsurers of property and casualty risks usually maintain an overall premium-to-net worth (capital plus surplus) ratio of between 1.5:1 and 3:1. Assume that a reinsurer maintains a maximum premium-to-net worth ratio of 2.5:1. If the reinsurer's premium-to-net worth ratio is 2:1, the reinsurer has unused capacity to accept additional premium and assume the associated risk. As its premium-to-net worth ratio approaches 2.5:1, the reinsurer's ability to accept additional premium diminishes. A reinsurer can increase its capacity by increasing its capital or reducing its retained premium by ceding a portion of its premium and the associated risk to other reinsurers. Such an arrangement is known as a retrocession. A retrocession from a first reinsurer to a second reinsurer operates exactly as a cession from a primary insurer to the first reinsurer, except the first reinsurer becomes the ceding company instead of the primary insurer. Retrocessions increase the reinsurer's capacity by reducing its retained or net premium, thereby reducing its premium-to-net worth ratio.

Investor Participation in Insurance, Reinsurance, and Retrocessional Risk. At present, there are only two ways in which investors can participate in insurance and reinsurance risk. The basic method is to invest in a public insurance or reinsurance company, most of which are very large, ongoing organizations writing many lines of business. Because of the inherent difficulty in accurately estimating losses not yet incurred, the investor is exposed to inadequately booked liabilities when the investment is made. It is not rare for a large public insurance company to increase its loss reserves by $2 or $3 billion. There are only a few public insurance companies that specialize in one or a few lines, so most investors must accept across-the-board risk when they buy shares of a public company.

The polar alternative of an ongoing insurance or reinsurance company is investment in a single treaty or a fixed package of treaties, available to wealthy investors directly or through hedge funds. The single treaty, which usually is for a property catastrophe risk (hurricane or earthquake), concentrates rather than spreads risk. A package of reinsurance treaties which is uncommon, may spread the risk, but locks in the risk for the investment period. If the package has a significant portion of deteriorating risks, the investor cannot liquidate the investment without a large loss.

### SUMMARY

The system disclosed herein relates to methods and apparatus for securitizing risk and providing an equity security whereby investors may participate in insurance, reinsurance and retrocessional risk. According to the system, a limited-life business entity or special purpose corporation (“SPC”) is created. The SPC will actively underwrite risk. Shares in the limited life SPC are marketed and sold to investors. The capital raised through the sale of securities is invested by the SPC in the equity and debt markets. The SPC leverages its invested capital by writing premium for risk assumed at a multiple of its capital and surplus. The risk assumed by the SPC may be primary insurance, reinsurance, or retrocessional property and casualty, life and health, or surety and guaranty risk.

In contrast to the existing modes of participating in insurance and reinsurance risk—by investing in the shares of an insurance or reinsurance company or by investing in a single catastrophe treaty or a package of treaties—the newly-formed SPC wholly avoids the detriment of unbooked prior loss; can be highly selective in underwriting; and can readily adjust to changed market conditions to take advantages of opportunities and reduce or avoid worsening risks. The dynamic underwriting of the SPC distinguishes it from the static investment in reinsurance risk through a single treaty or package of treaties. Its partnership with insurers or reinsurers results in reduced operating expense because the SPC is primarily using the underwriting facilities of its partner. Furthermore, the SPC does not compete with traditional reinsurers in that it has a specific finite purpose and does not invest in marketing, staffing, perpetuation and infrastructure. It is purely a financing vehicle to participation in the insurance and reinsurance markets.

The SPC actively underwrites risk for premiums for a specified limited period of time—e.g. 5 years, although it can be for a shorter or longer period. In one embodiment of the system, the risk assumed by the SPC during this active underwriting phase will be short-tail casualty and property risk, with the tail progressively shortened by writing a larger portion of property risk as the end of the active underwriting phase approaches. By contracting the tail, the likelihood is increased that residual risk liability can be fully runoff during a passive runoff phase which follows the active underwriting phase. The SPC manages the runoff for a predefined period of time—for example, 5 years although it might be shorter or longer depending on the tail of the risk assumed—during which it disposes of all remaining risk liability by paying out losses, commuting reinsurance treaties, or purchasing retrocession-to-close so that the SPC can be wound up as scheduled. In support of this objective, the SPC sets aside 3% of gross collected premium to pre-fund the reinsurance-to-close. The durations of both the underwriting phase and the runoff phase are fixed or fixed within narrow limits at the time the SPC is formed. For example, each phase may be absolutely fixed at from 3 to 10 years, or each phase may be fixed within a range such as 5 to 7 years. The duration of the phases need not be the same. One could be fixed and the other within a range.

Each investor has the choice of liquidating the investment at the end of either the underwriting phase or the runoff phase. At the end of the underwriting phase, investors may opt to redeem their shares and receive a cash distribution of their proportionate share of the SPC's net worth, less the cost of purchasing reinsurance-to-close for risk of the SPC that is not fully matured. At that time, investors may alternatively elect to transfer (i) their proportionate share of the SPC's assets less the cost of reinsurance-to-close or (ii) their proportionate share of the SPC's assets and liabilities, to a new SPC in a tax-free transaction. If the cost of the reinsurance-to-close is more than or less than a pre-funded amount set aside for such reinsurance, there will be an additional charge assessed against or credited to the shareholders receiving a cash distribution or rolling over their investment into a new SPC.

Investors who retain shares in the SPC for the runoff period will, at its end, receive their full share of the assets, without a charge for reinsurance-to-close, assuming all of the SPC's liabilities will have been resolved by that time. If there is any residual liability, it will be discharged from their share of the special fund for purchasing reinsurance-to-close, subject to an additional charge to them if the fund is insufficient or an increased distribution if it is excessive.

A final option is that investors who remain with the SPC until it is wound up may opt for a tax-free rollover of their proportionate share of the SPC's assets and liabilities into a new SPC organized and operated in the same manner. In this scenario, reinsurance-to-close would be purchased for any residual risk liability not transferred to the new SPC.

Additional features and advantages of the present system are described in, and will be apparent from, the following detailed description of the system and the proforma financial projections for a model SPC illustrating one of the many possible embodiments of the system.

### DESCRIPTION OF THE FIGURES

Each of the Figures, listed below, are illustrations of a model embodying the presently disclosed system.

FIG. 1 is a chart showing a typical reinsurance treaty structure.

FIG. 2 is a flowchart showing a method of securitizing risk and providing a new equity security whereby investor can participate in such risk.

FIG. 3 is a table describing the assumptions underlying proforma financial projections of a model SPC organized and operated according to the present system.

FIG. 4 is a multi-year balance sheet of the model SPC.

FIG. 5 is a multi-year income statement of the model SPC.

FIGS. 6A thru C is a table showing by month the assumed gross premium of the model SPC.

FIG. 7 is a table showing by quarter gross assumed premium of the model SPC.

FIG. 8 is a table showing by quarter funds set aside by the model SPC for purchasing reinsurance-to-close.

FIG. 9 is a table showing by quarter net premium written each quarter by the model SPC after the 3% setaside for reinsurance-to-close.

FIGS. 10A thru 10F form a table showing the timing between the month that premium is written and when the premium is earned.

FIG. 11 is a table showing by quarter net earned premium of the SPC.

FIG. 12 is a table showing by quarter unearned premium of the SPC.

FIG. 13 is a table showing by quarter gross premium collections by the SPC.

FIG. 14 is a table showing by quarter net premium collections after the 3% setaside for reinsurance-to-close.

FIG. 15 is a table showing ceding commission incurred.

FIG. 16 is a table showing management fees incurred.

FIG. 17 is a table showing Federal excise tax incurred.

FIG. 18 is a table showing ceding commission paid.

FIG. 19 is a table showing management fees paid.

FIG. 20 is a table showing Federal excise tax paid.

FIG. 21 is a table showing incurred net losses and loss adjustment expenses (“LAE”).

FIGS. 22A thru F is a schedule of loss and LAE paid corresponding to the quarter the loss was incurred.

FIG. 23 is a table showing by quarter net losses and LAE paid.

FIG. 24 is a table showing cash flow from operations.

FIG. 25 is a table showing invested assets at the beginning of each quarter and quarterly earned investment income.

FIG. 26 is a table showing by quarter investment income received.

FIG. 27 is a table showing annual realized capital gains.

FIG. 28 is a table showing cash flow from investment and operations.

FIG. 29 is a table showing projected returns to investors in the model SPC.

FIG. 30 is a block diagram of an example communications system.

FIG. 31 is a block diagram of an example computing device.

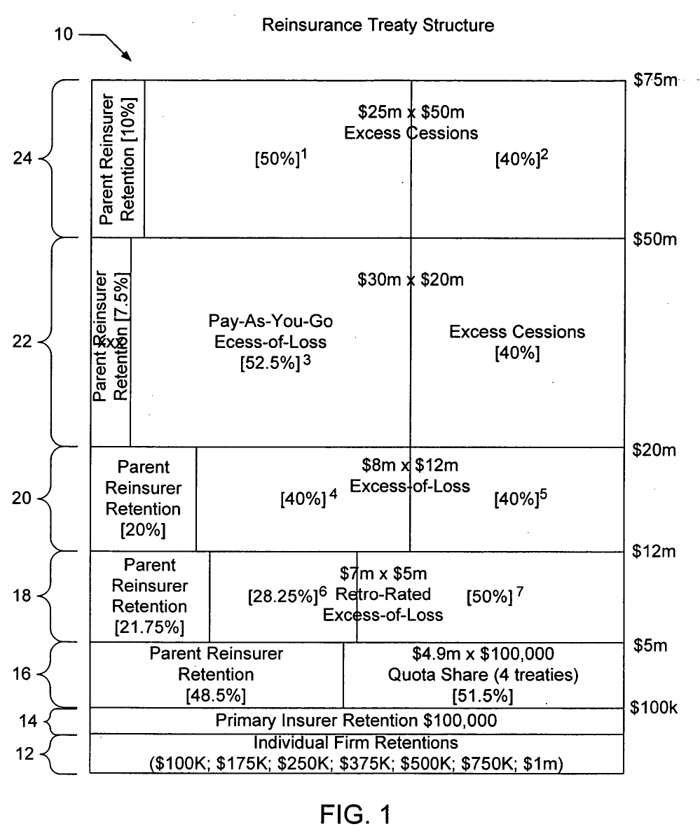

### DETAILED DESCRIPTION OF EXEMPLARY EMBODIMENTS

The system comprises methods of securitizing insurance, reinsurance and retrocessional risk through a new and unique type of investment, through which investors may easily and efficiently participate in the potential financial rewards from underwriting such risks. Embodiments of the system may be tailored to special applications for each of these levels of risk transfer.

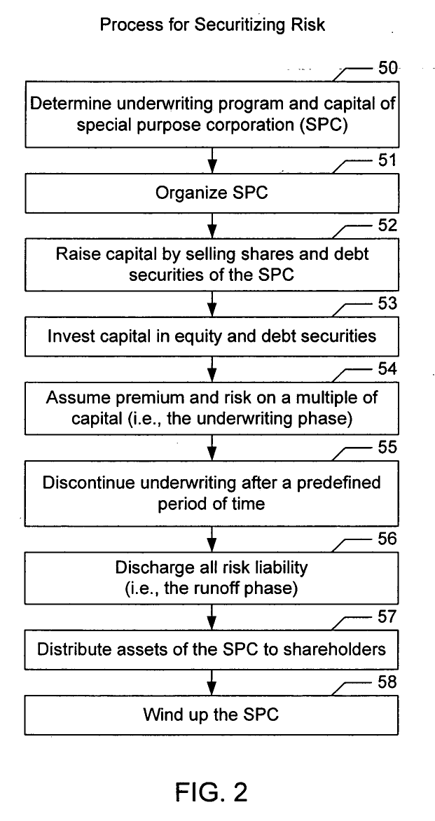

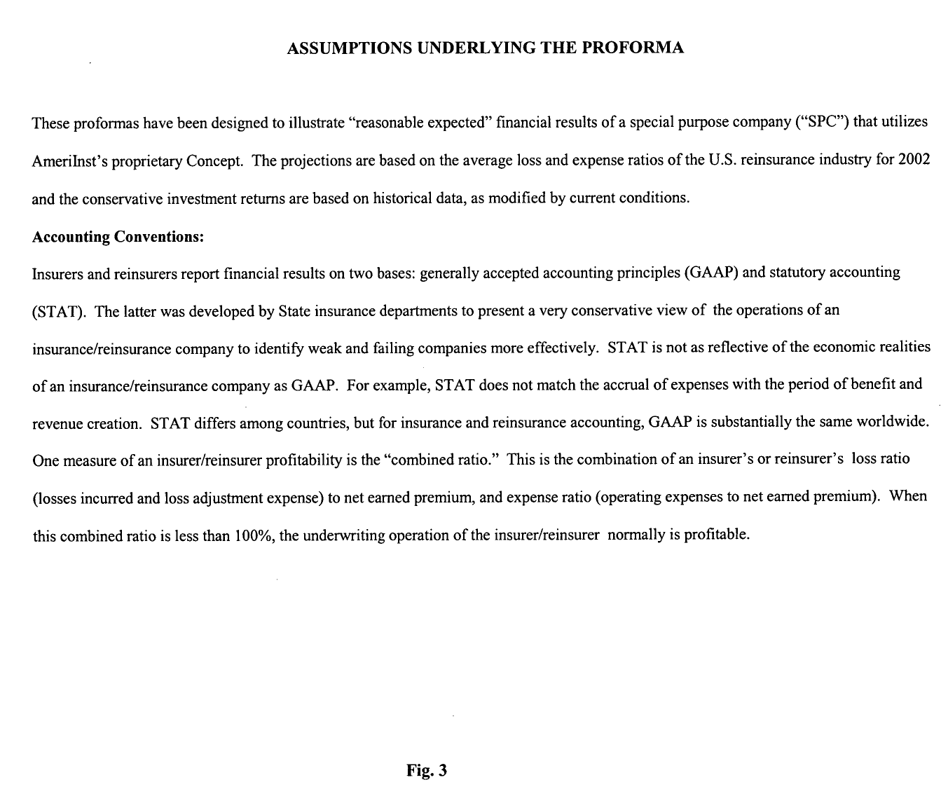

Summary Description. FIG. 2 is an example of a flow chart of a method for securitizing reinsurance risk. The method begins by determining an underwriting program and capitalizing the SPC (block 50). Questions that are typically resolved during this pre-organization planning include: Will the SPC finance insurance, reinsurance or retrocessional risk? Will it involve property and casualty, life and health, or surety and guaranty risks? Within those categories, what risks will be eligible and in what mix and with what diversification? Will there be a single contract with one reinsurer, or will the SPC enter into separate negotiations for each risk it assumes? The foregoing decisions will result in a predetermination of the duration of both the underwriting phase and the runoff phase, and therefore the overall life of the SPC.

Next the limited-life SPC is created (block 51). The purpose of the SPC is to participate in insurance, reinsurance or retrocessional risk as chosen at block 50. The SPC has a limited life in that it is established to exist for a predetermined duration, divided into a predetermined period in which it actively underwrites and assumes risk and a predetermined runoff period, at the end of which the SPC will be wound up and dissolved. Once formed, the SPC raises capital by marketing and selling common and preferred shares and surplus notes and other debt instruments of the SPC to investors (block 52). The equity and debt capital raised through the sale of securities of the SPC provides resources to support the assumption of risk by the SPC. The capital raised is then invested in capital markets issues of debt and equity securities (block 53). Based on this capital, the SPC underwrites insurance, reinsurance or retrocessional risk by assuming premium and associate risk liability as a multiple of its capital and according to its underwriting guidelines (block 54). After a pre-defined period of time referred to herein as the active underwriting phase (e.g., 5 years), the SPC discontinues underwriting (block 55). But the SPC continues to earn on its invested net worth and loss reserves, and runs off the previously assumed liability, referred to herein as the runoff phase (block 56). During the runoff phase (e.g., 6 years), the SPC resolves its risk liability by paying off losses, commuting treaties and purchasing reinsurance-to-close. At the end of the runoff phase, the assets of the SPC are distributed to the shareholders and/or to a newly organized SPC incident to a tax-free transaction (block 57). Finally, the SPC is dissolved, ending its legal existence (block 58).

Business entity. In an embodiment of the system, the SPC is incorporated in Bermuda as a special purpose vehicle, licensed by the government of Bermuda (although there are other suitable venues) as an insurance or reinsurance company to assume a diversified aggregation of insurance, reinsurance or retrocessional risk. Shares in the SPC will be issued in one or more classes of common shares. One or more classes of preferred shares may also be offered. Finally, surplus notes, which are legally debt but are treated as capital for regulatory purposes, and/or ordinary debt instruments may also be offered by the SPC to investors. It is expected that the share offerings of each SPC will normally range upwards from $100 million, sometimes augmented by surplus notes or other debt, but an SPC might be organized with less capital.

Operating Alternatives. According to various embodiments of the system, the SPC may participate in reinsurance treaties either by direct cessions from primary insurers or retrocessions from other reinsurers. The principal customer base of these SPCs will include small to mid-sized commercial stock company insurers and reinsurers; mid-sized mutual insurance companies; subsidiaries of large insurance companies; and group and single owner captives.

Two principal types of operating modes by the SPC are contemplated. Under the first type, the SPC will contract with a reinsurer to participate with the reinsurer in new and renewal treaties. By this arrangement, the SPC will stand shoulder-to-shoulder with that reinsurer in assuming cessions directly from primary insurers or other reinsurers. Although it may assume a smaller percentage of the placements, the SPC typically will assume a share of the ceded risk equal to that retained by the reinsurer. This effectively doubles the reinsurer's line capacity without incurring the cost of raising capital. This added capacity makes the reinsurer more attractive to brokers, which will lead to increased broker traffic, enabling the reinsurer to be more selective as to the quality and type of risk it assumes, thereby increasing its potential for increased underwriting profits. In this arrangement, the SPC essentially delegates its pen to the reinsurer, signing onto the treaties entered by the reinsurer, subject only to the SPC's underwriting guidelines and individual approval of each risk assumed.

The second operating mode is participations negotiated, directly or through a broker, in numerous treaties with several or many ceding reinsurers. These may be direct cessions by a primary insurer or an assumption by a reinsurer with a concurrent retrocession to the SPC.

Underwriting Guidelines. The SPC will disclose to potential cedants and brokers, as well as to investors, the types of risks it will assume. In one embodiment of the system, the SPC will accept only cessions involving non-volatile property and short tail casualty risk of personal and commercial lines. In order to ensure sound underwriting by the cedant, the SPC will require that the cedant retain risk from each cession at least equal to that ceded to the SPC. Volatile lines such as high risk product liability, environmental, catastrophic property and long-tail casualty risks, would not be accepted. Currently, medical and large accounting firm malpractice risks would be excluded. Some lines, such as professional liability for small accounting firms, would be underwritten with high selectivity. The acceptability of risks will be continuously monitored for volatility and profitability based on loss experience, prevailing loss trends, existing market premium rates, and current premium trends. Individual assumptions of risk normally would be limited so that premium received from a transaction will never represent more than 5% to 7% of the SPC's expected total annual premium. Because of the objective that the ceded risk be short tail, assumptions principally will be of “working layer” quota share treaties, which develop more quickly and are inherently less volatile than excess-of-loss treaties involving more severe but less frequent losses. Treaties will be widely diversified by line of insurance and by geography as well. Multi-year treaties will be acceptable when practical. Finally, for purposes of limiting residual risk, commutable treaties will be favored over non-commutable ones. Overarching the foregoing objectives of assuming short tail risk and diversification will be to seek and disproportionately be free of any remaining liabilities of the SPC. The second option is for investors to transfer their share of the SPC's assets and liabilities, or to transfer only assets after reinsurance-to-close is purchased to cover their share of risk liabilities, to a newly formed SPC in a tax-free transition. Investors who do not exercise either of these options will hold their shares to the end of the run-off phase, at which time the SPC will distribute all its assets, resolve its liabilities, and be wound up. At the end of the run-off phase, the third option is for the remaining investors to receive cash after purchasing any necessary reinsurance-to-close. The fourth option is for the remaining investors to transfer their share of assets and liabilities or to transfer only assets after reinsurance-to-close is purchased to cover their share of risk liabilities, in a tax-free transaction to a new SPC.

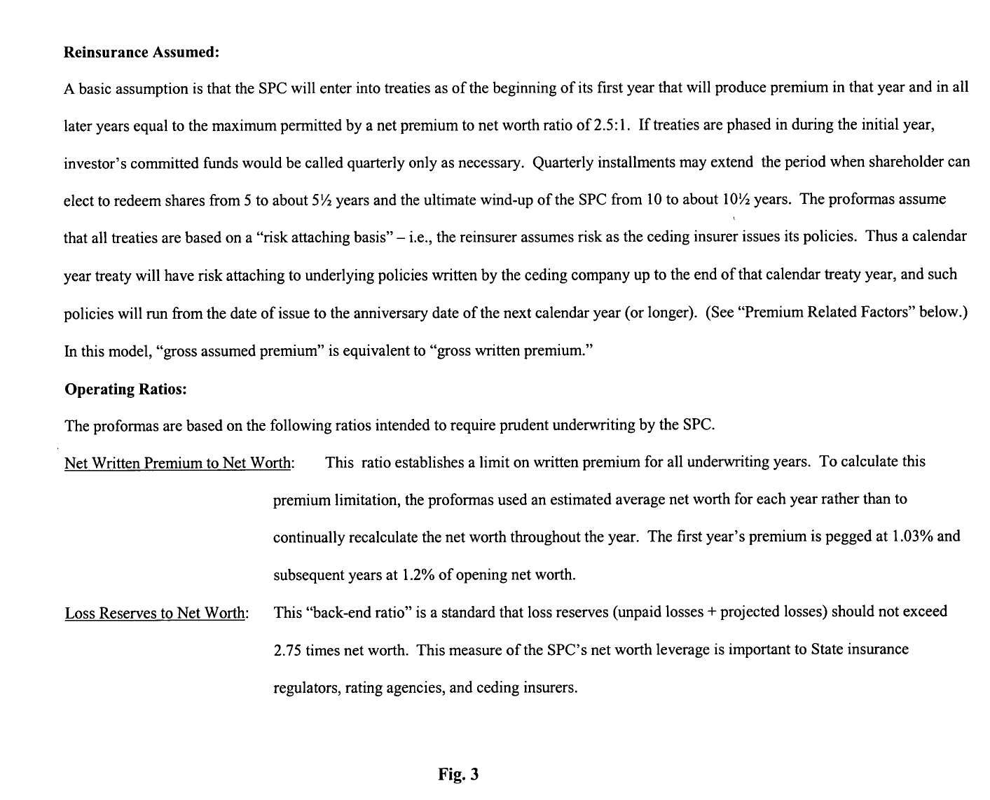

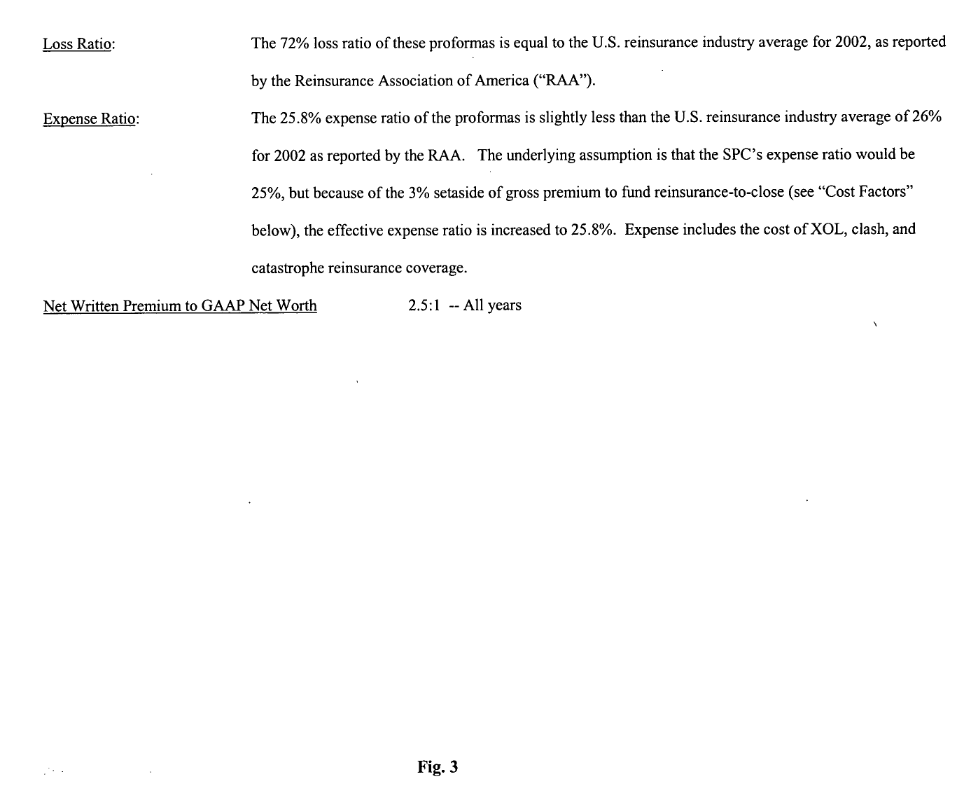

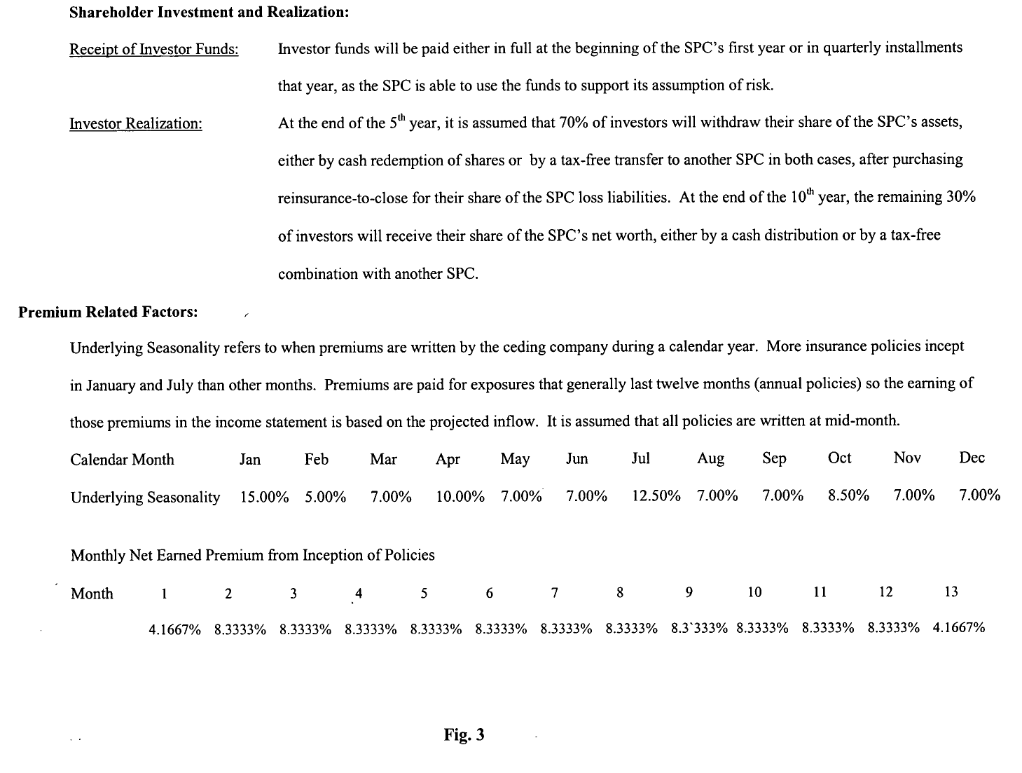

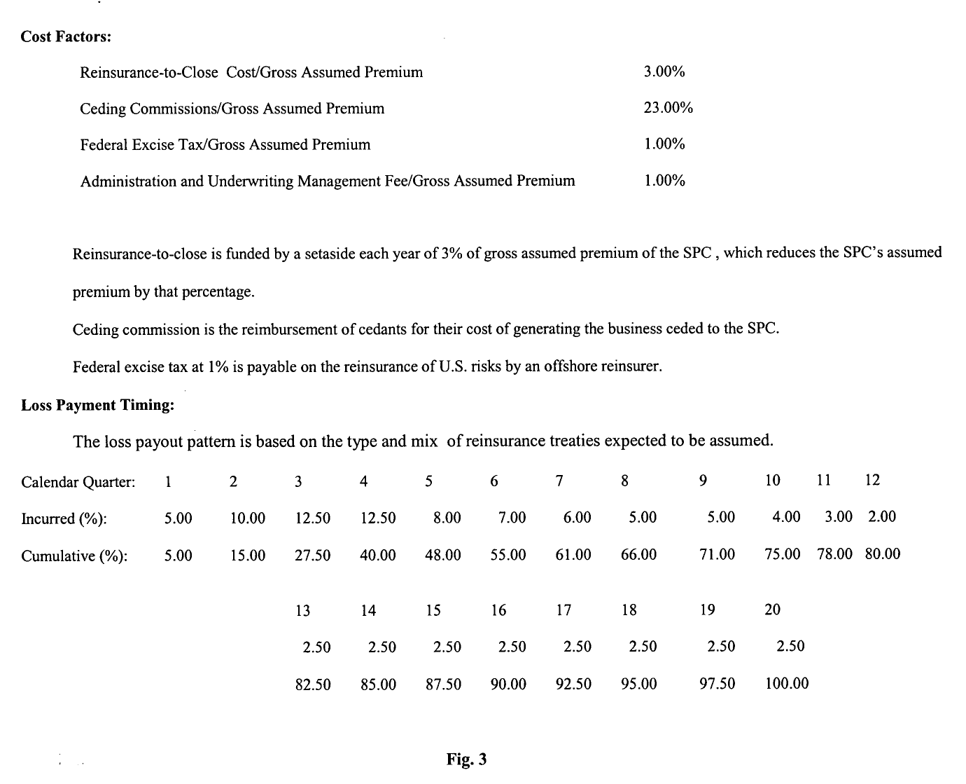

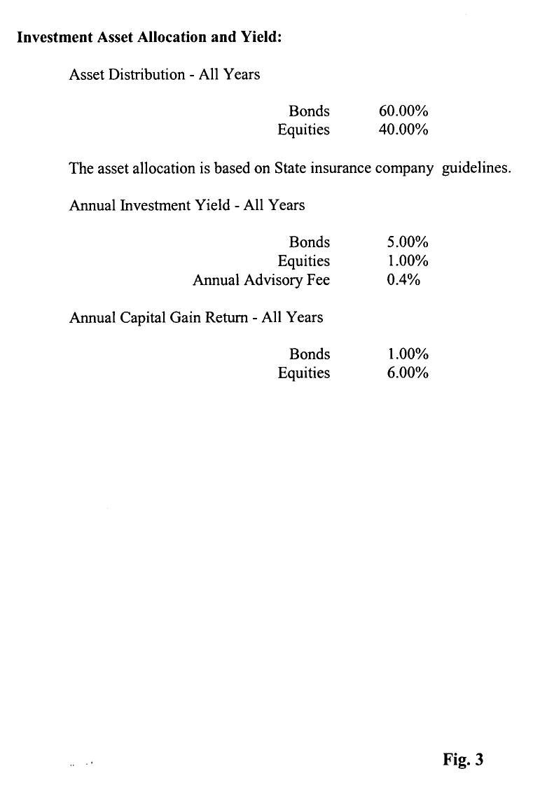

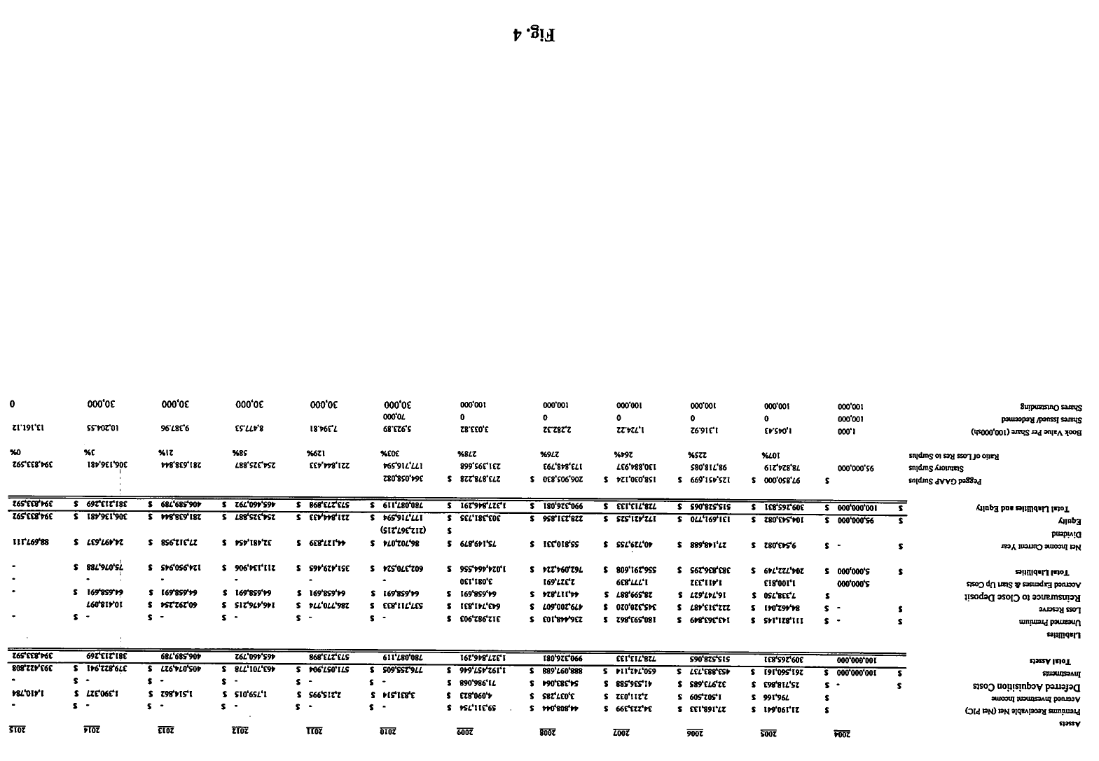

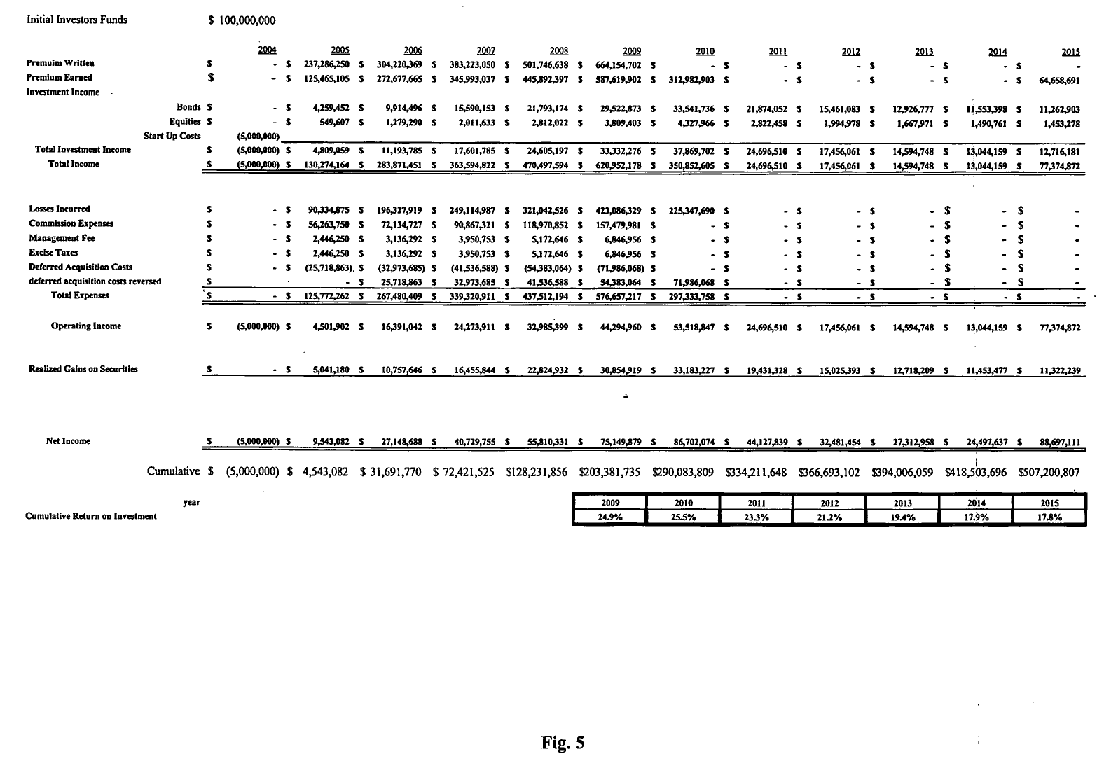

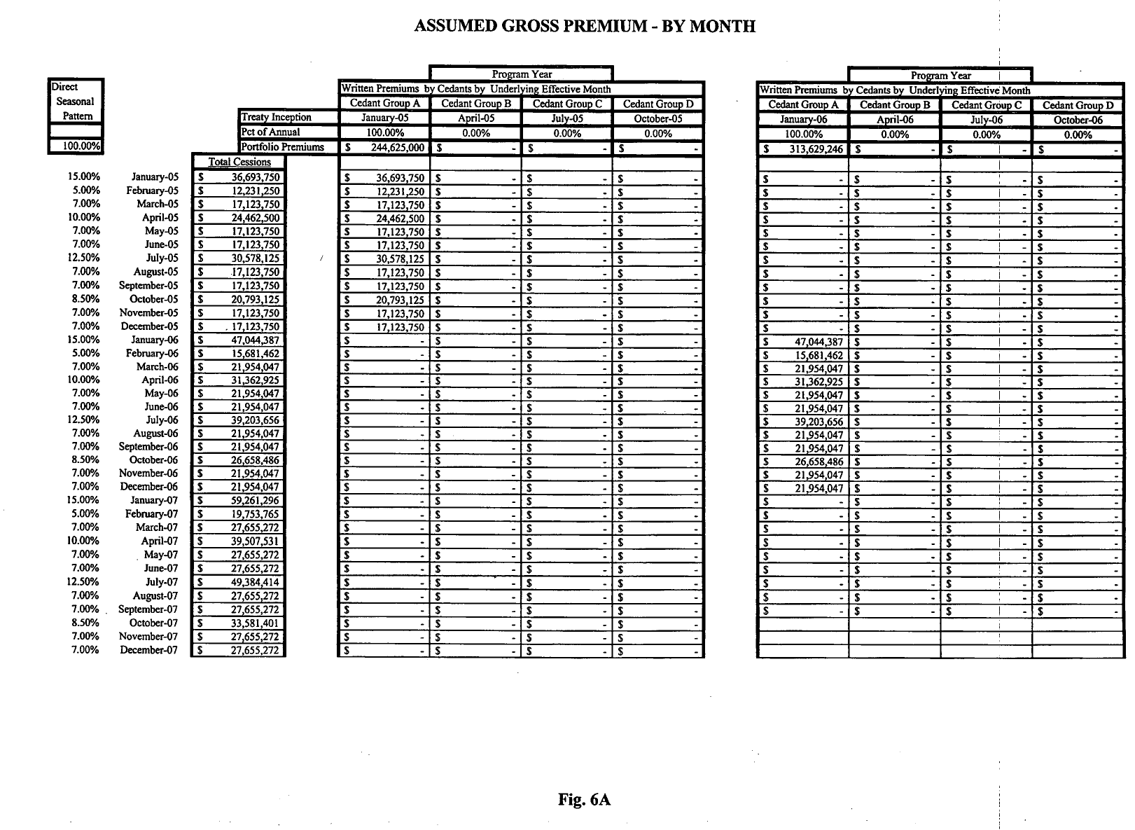

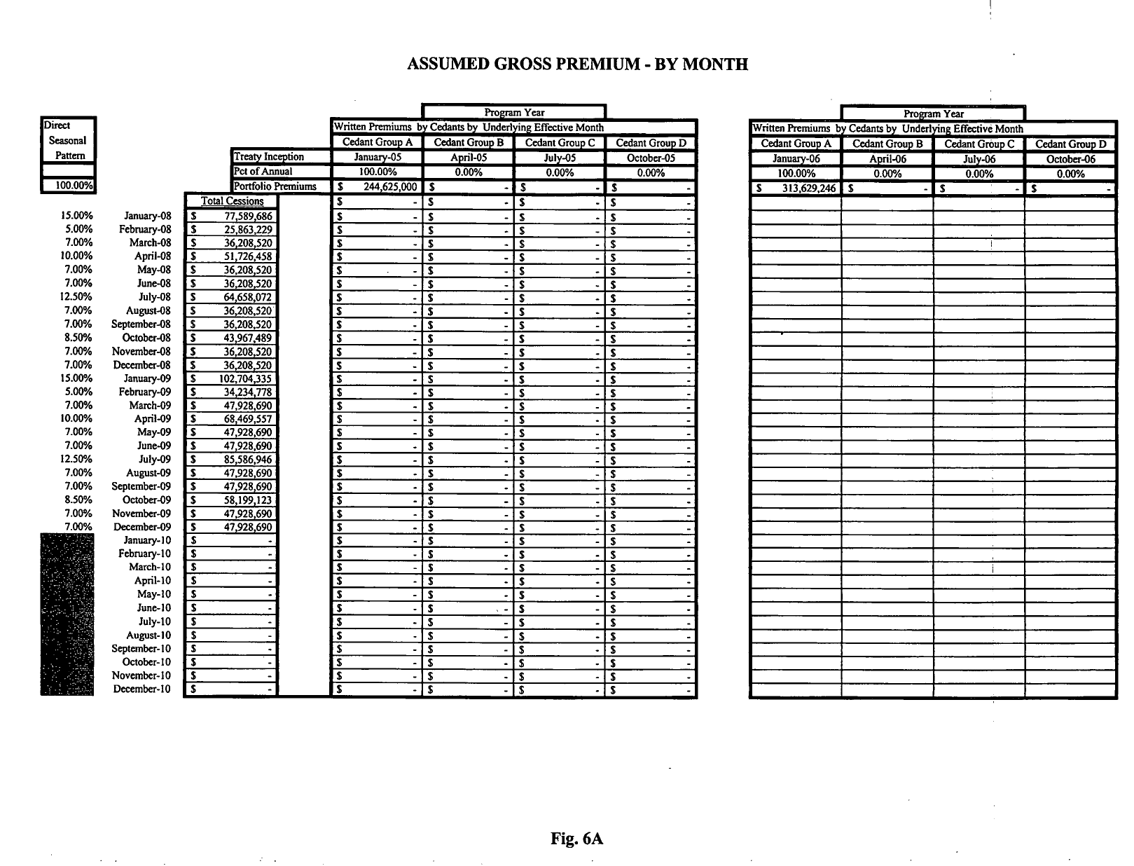

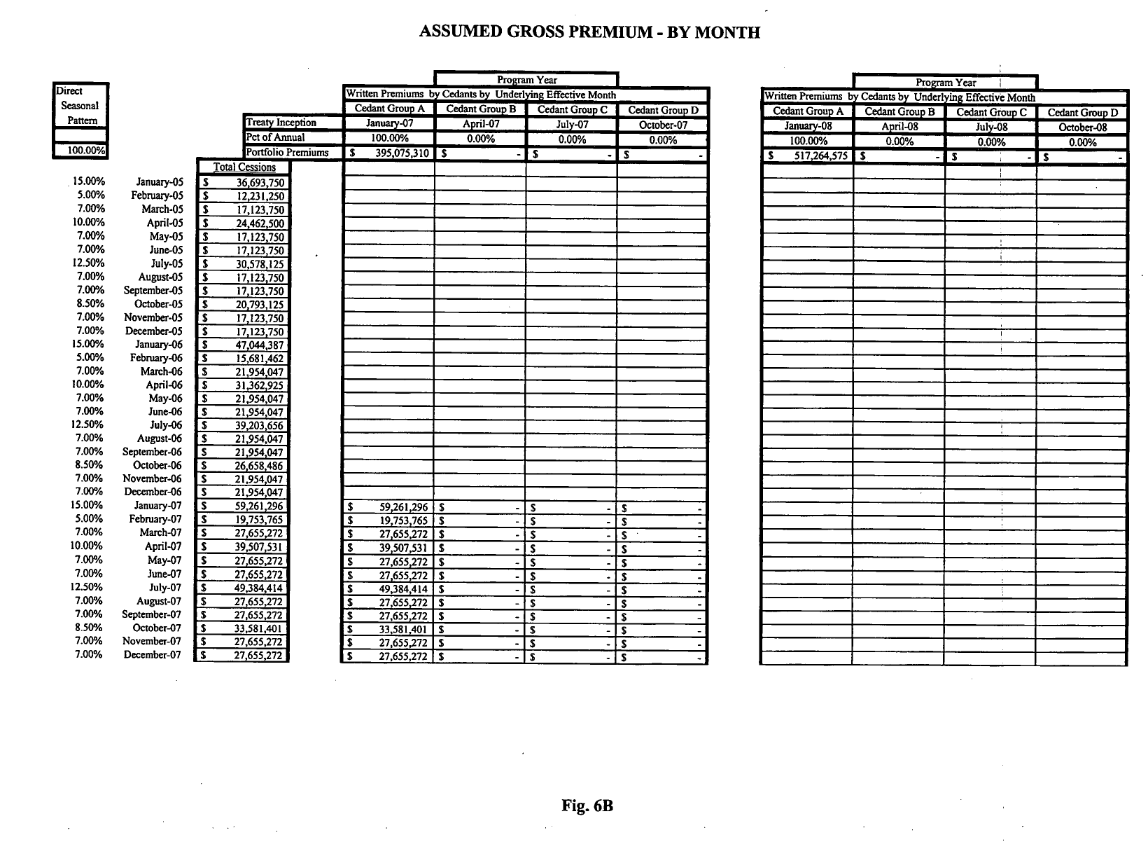

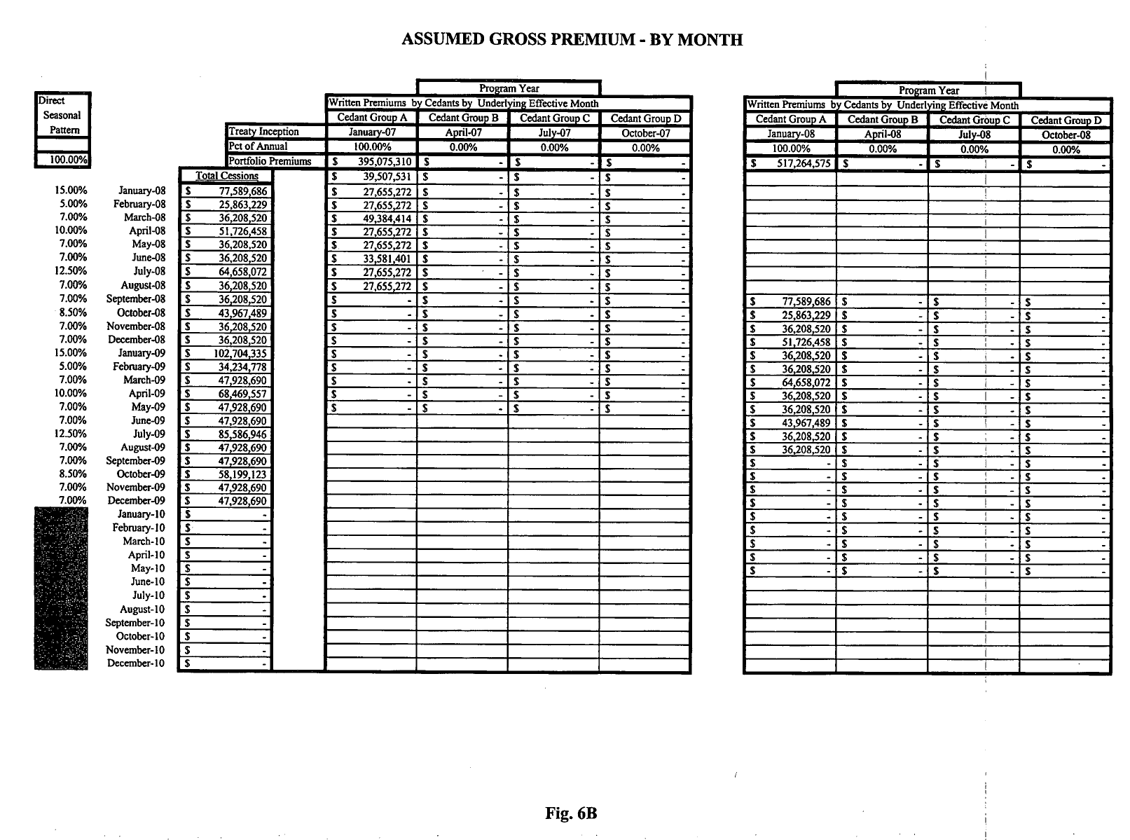

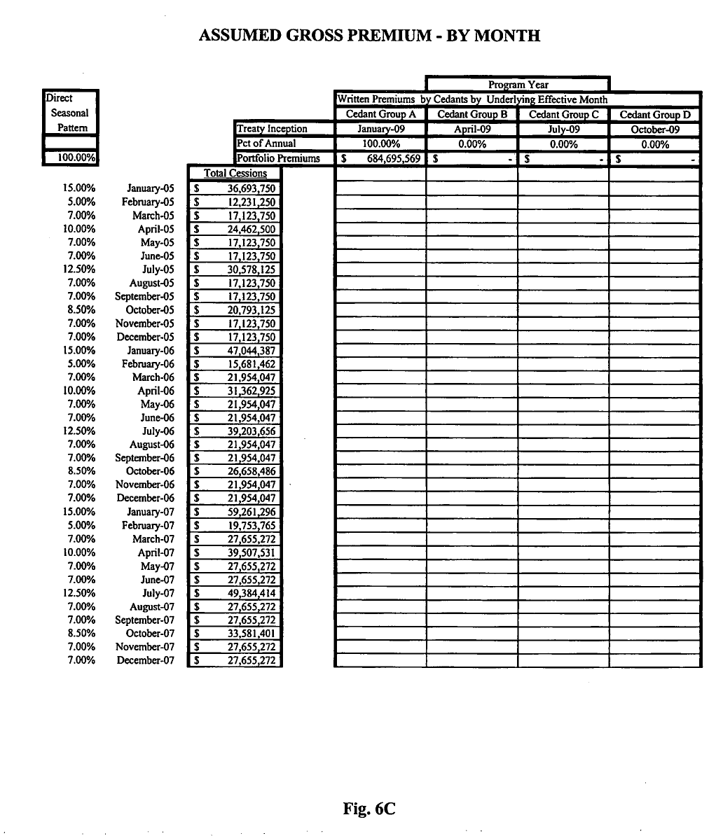

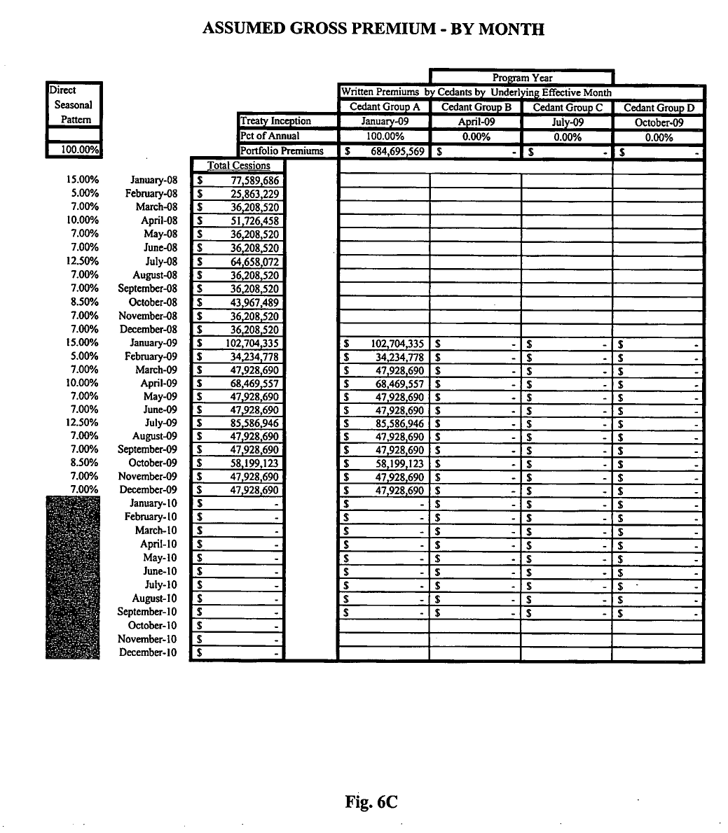

To illustrate the benefits of investing in an SPC according to the present system, proforma financial projections of a model SPC are provided by FIGS. 3 thru 29. This model is a “middle case” example among an infinite number of possibilities. FIG. 3 describes the assumptions upon which the model SPC is based. Summary proforma financial projections include a balance sheet (FIG. 4); and an income statement (FIG. 5). Supporting tables are provided in FIGS. 6 thru 28, which illustrate how the values of the financial statements are derived. The tables will be described as necessary to provide a detailed description of the performance of the model SPC based on the underlying assumptions.

The starting point is an examination of the assumptions listed in FIG. 3. All of the assumptions on which the present model is based are realistic moderate to conservative estimates of what can be expected of the model SPC's operations. In this example, the SPC will be capitalized at $100 million. The funds are deemed raised in assume risk from primary insurers or reinsurers having superior long-term underwriting track records.

Illustrative Financial Model. The foregoing underwriting guidelines and diversification requirements are one model illustrated by FIGS. 3 thru 29. Another SPC could adopt much more conservative or more liberal guidelines based on investor interest or, market conditions. This could include highly volatile lines, modulated by selective reinsurance, to seek a higher return.

According to the system, the initial phase of the SPC will include active underwriting to assume risk liability. This underwriting phase will last for a predetermined period of years—for example 5 years—after which the SPC will enter a passive phase to run off then existing obligations. During the run-off phase, the SPC will continue to earn investment and underwriting income, and continue to pay losses on the risk that it assumed during its underwriting phase. The run-off phase also will last a predetermined period of time—for example, 5 years. If any non-matured risk remains at the end of this phase, it can be closed out by commuting open treaties and/or purchasing reinsurance-to-close or transferred to a new SPC as part of a tax-free merger or other type of combination. If no such corporate combination occurs, the SPC will be dissolved after all its assets have been distributed and liabilities resolved.

According to an embodiment of the system, investors in the SPC will have four options for realizing on their investment in addition to holding it to maturity. The first option is to redeem their shares at the end of the underwriting phase—e.g., the fifth year. Investors who choose this option will receive their percentage share of the net worth of the SPC, less a charge for purchasing reinsurance-to-close to cover their share of the remaining liability from the SPC's active underwriting phase, so that they will 2004, and operations begin at the outset of 2005. The example SPC's funds will be invested in the capital markets according to the asset allocation shown in FIG. 3, namely 60% in bonds and 40% of equities, which is based on State insurance regulation. Expected investment income and capital gains, both based on historical averages, are shown in FIG. 3. It is assumed that funds invested in bonds will produce a 5% annual yield and equities 1%. Bonds are expected to realize capital gains of 1% per year and equities 6%. The SPC will incur an annual investment advisory fee each year in the amount of 40 basis points (0.4%) of the fair market value of the portfolio.

FIG. 3 also describes regulatory limitations that affect the financial statements. The SPC will leverage its net worth (capital and surplus) by writing insurance and/or reinsurance premium as a multiple of such net worth. The model SPC will write premium at a maximum leverage of 2.5:1 of premium-to-net worth. Underwriting and other factors may cause this ratio to vary from 2.5:1, but the ratio will be maintained as close as feasible to this target. A fund will be accumulated to purchase reinsurance-to-close by annually setting aside 3% of gross collected premium to cover residual liability (i) of investors who opt to redeem their shares at the end of the fifth year and (ii) when the SPC is being wound up. The model projects that the SPC will be required to pay ceding commission of 23% of assumed gross premium. Each year the SPC will pay a 1% Federal excise tax and a 1% management fee measured by assumed gross premium.

Additional premium related factors are described in FIG. 3. The model assumes that the SPC will not immediately write its full capacity of premium (2.5 times net worth) as of January 1, but that seasonal adjustment factors will influence when premium is written throughout the year. FIG. 3 includes a schedule of such adjustment factors. Estimates of the total written premium each year are multiplied by the appropriate seasonality factor to determine the amount of premium that will be written each month. For example, the schedule shows that 15% of the yearly total will be written in January, 5% will be written in February, and so forth. For simplicity's sake, it is assumed that all annual treaties are effective as of the first day of the year. Finally, FIG. 3 includes incurred loss and loss payment timing projections. The model assumes losses and loss adjustment expenses (LAE) of 72% of net earned premium. Incurred losses will be paid over 20 consecutive quarters beginning in the quarter the loss arises.

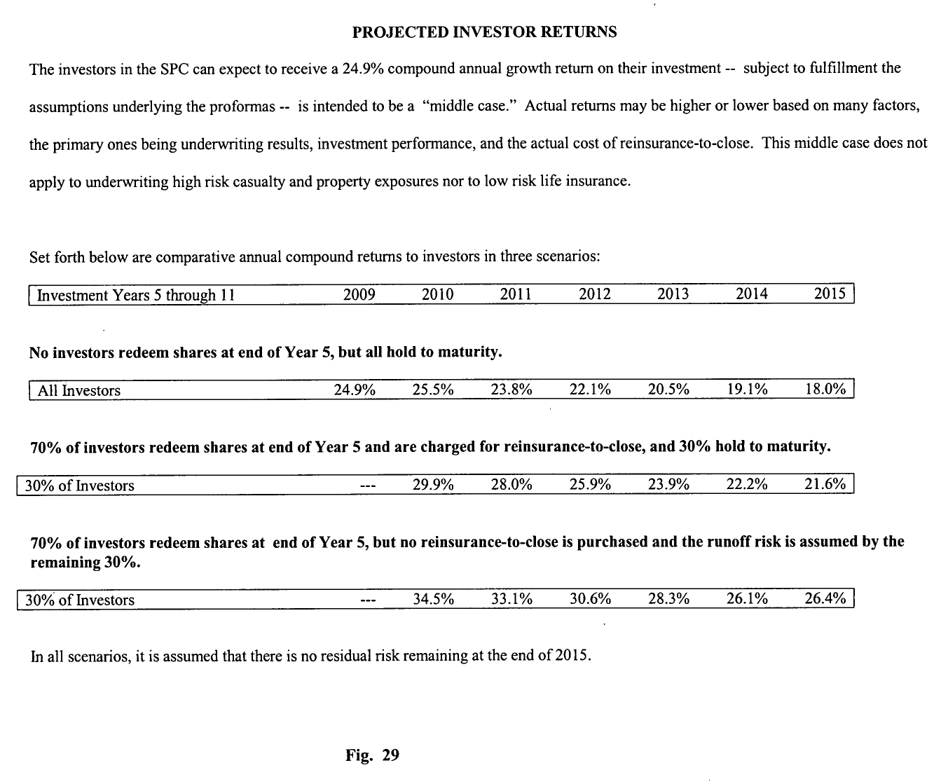

These assumptions underlie the detailed financial projections contained in the model. FIG. 29 is a table showing the high returns to investors from an investment in an SPC organized and operated according to the present system.

The proforma projections assume that the SPC was created and capitalized in 2004 and that it began active operations in 2005. Referring first to the balance sheet, FIG. 4, the total assets of the SPC at the close of 2004 are $100,000,000. This represents the aggregate amount invested by investors who purchased shares in the SPC. This is reduced by $5,000,000 for start-up costs associated with forming the corporation, raising capital and beginning operations (brokerage fees, marketing and legal fees). These costs, which appear as a liability on the balance sheet, are conservatively expensed in 2005 rather than be capitalized and amortized over the life of the SPC. The remaining $95,000,000 of shareholder equity represents the funds with which the SPC begins operations in 2005.

These funds are invested 60% bonds and 40% equities according to the asset allocation described in FIG. 3. Thus, at the beginning of 2005, $57,000,000 are invested in bonds and $38,000,000 in equities. These investments begin earning interest and dividend income immediately at the start of 2005. Before calculating investment income and capital gains earned, it is necessary to examine how the model accounts for the ongoing process of writing and collecting premium and paying losses. From this, it can be projected how operating cash flows will increase invested funds that will directly increase investment returns.

As the SPC began operations in 2005 with a $95,000,000 net worth, it can write $237,500,000 worth of premium during 2005 while staying within the limits of the desired 2.5 premium-to-net worth ratio. However, this value ignores the fact that as the year progresses, income is being earned both from operations and from investment of the funds. This increase the SPC's net worth, thereby increasing the SPC's ability to write premium. This is calculated in the model by multiplying the surplus at the beginning of each year by an adjustment factor and is identified as the “Pegged GAAP surplus” on the Balance Sheet. The Pegged GAAP surplus is then used as the basis for determining the total premium that can be written for the year. Start up factors are expected to delay premium collections in the first year and limit the initial growth of the surplus. Accordingly, the surplus adjustment factor for the first year is limited to 3%. For each subsequent year, however, the surplus adjustment factor is 20%.

Since net worth at the end of 2004 is $95,000,000, application of the 3% growth factor for 2005 results in a Pegged GAAP surplus of $97,850,000. Multiplying this amount by 2.5 determines the SPC's capacity to write $244,625,000 ($97,850,000×2.5) during 2005. The model assumes that the SPC will write premium to its full capacity each year.

Premium written each year is spread throughout the year. The amount of premium written each month will vary according to the seasonality factors shown in FIG. 3. FIG. 6 shows a table of premium written each month by the SPC. The values are derived from the total written premium for the year multiplied by the appropriate seasonality factors shown in the left-hand margin of FIG. 6. This is equivalent to assumed gross premium, broken out by quarter in the table shown in FIG. 7, along with calendar year-to-date and the cumulative totals. Summing the quarterly totals for 2005 confirms that $244,625,000 of assumed gross premium is written in 2005. The 2005 income statement (FIG. 5) shows $237,286,500, which is net of the cost of reinsurance-to-close.

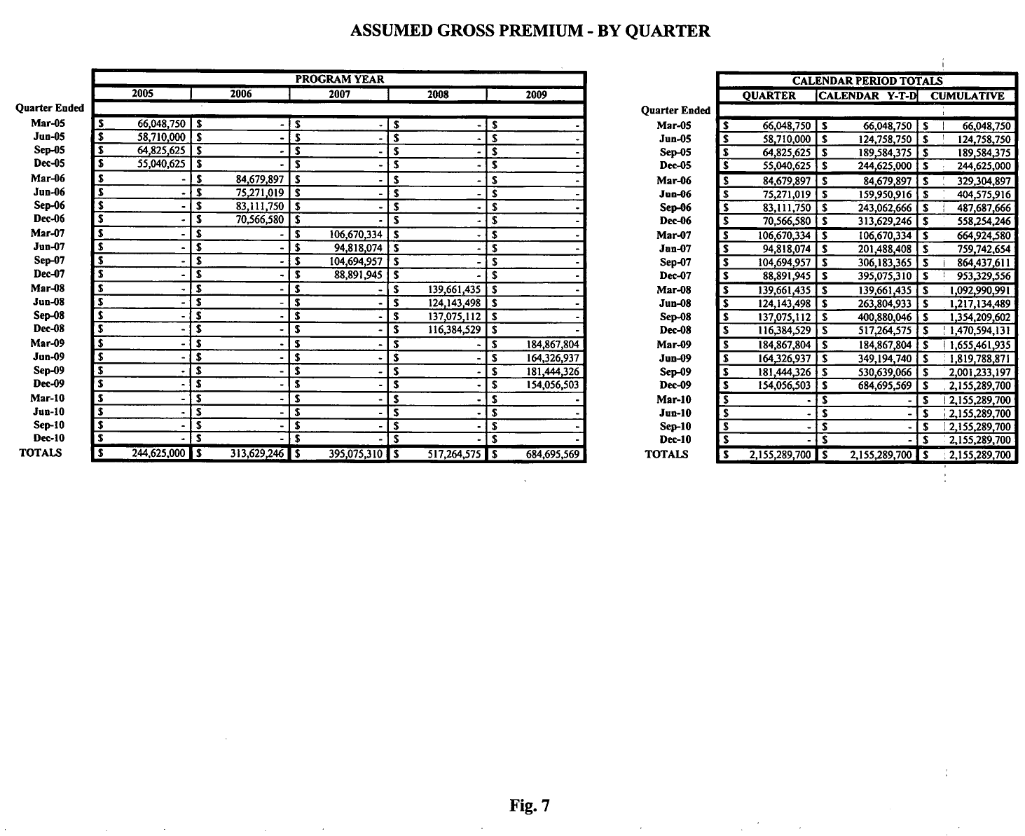

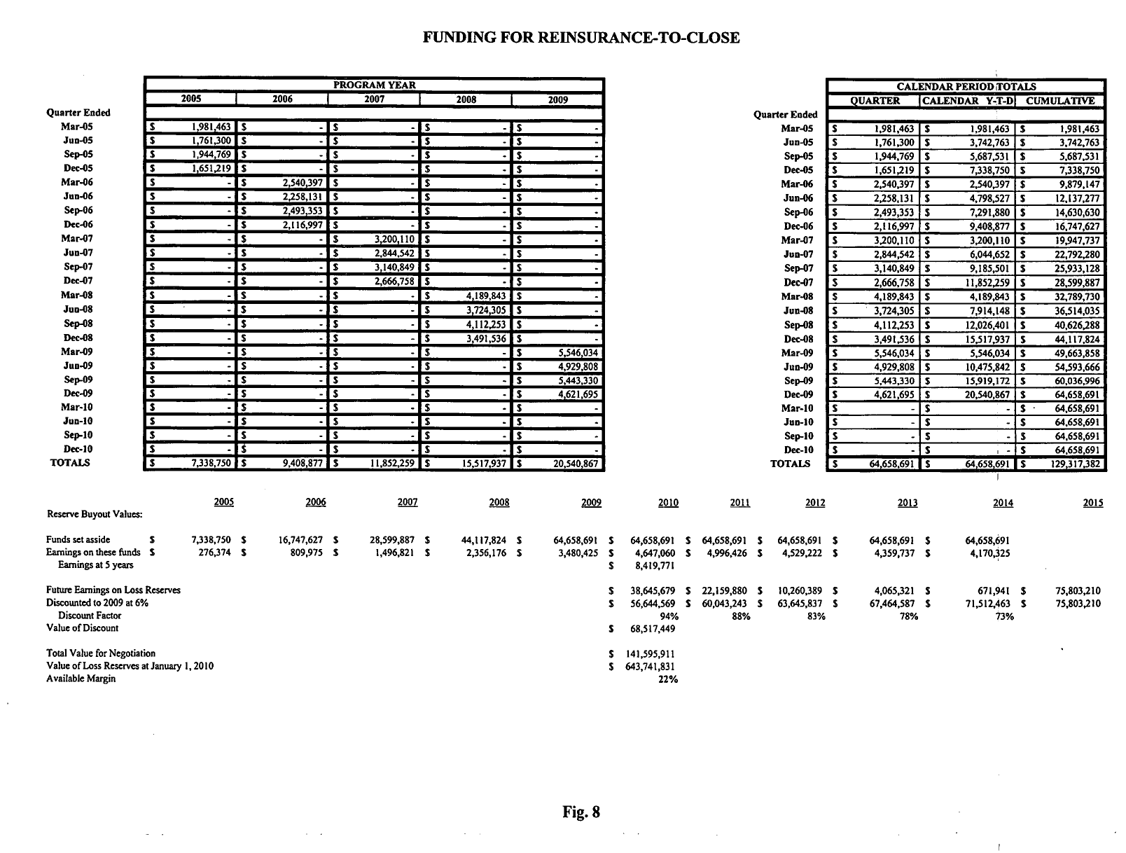

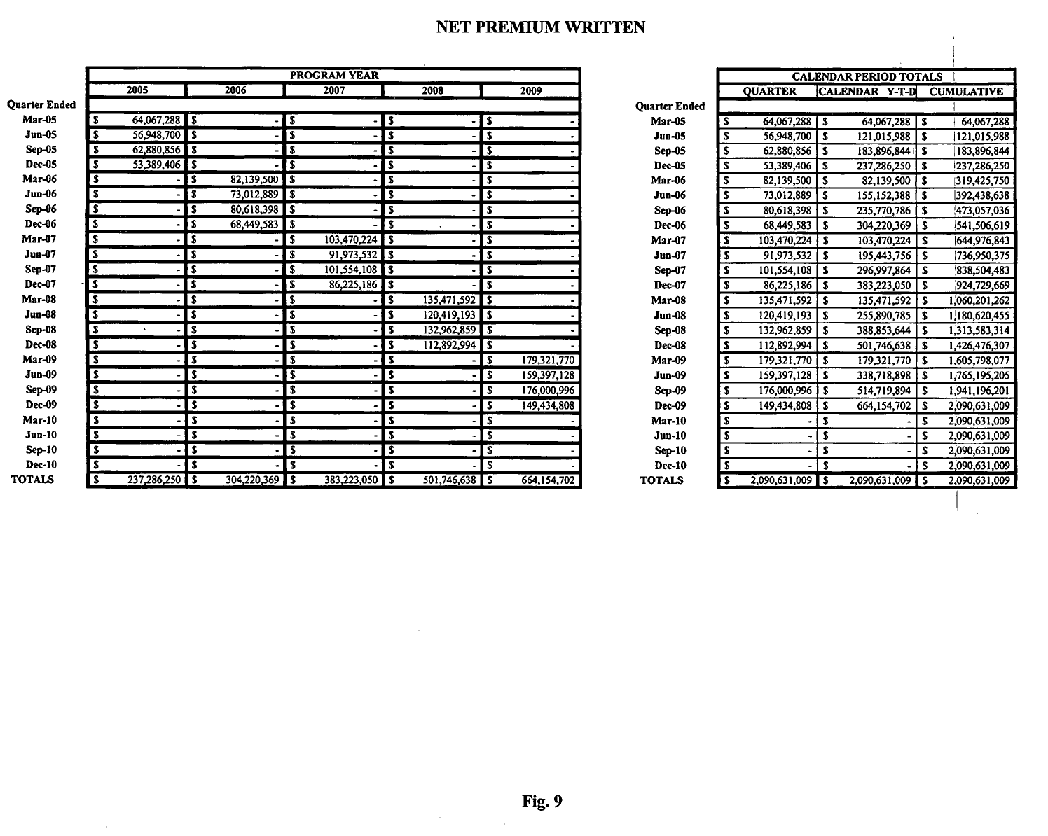

Not all of the premium the SPC writes each year is treated as income. As indicated in the assumptions of FIG. 3, each year the SPC sets aside 3% of gross written premium for the purpose of funding the purchase of reinsurance-to-close to cover residual losses for those investors who opt to redeem their shares after five years and of such reinsurance-to-close when the SPC is wound up. FIG. 8 is a table showing the amount set aside each quarter for purchasing reinsurance-to-close. FIG. 9 in turn, is a table showing the net premium written each quarter after the 3% setaside is subtracted from the gross written premium. As shown in FIG. 8, the total setaside for reinsurance-to-close in 2005 is $7,338,750. This also appears as a liability on the Balance Sheet (FIG. 4). The resulting net premium written for 2005 is $237,286,250.

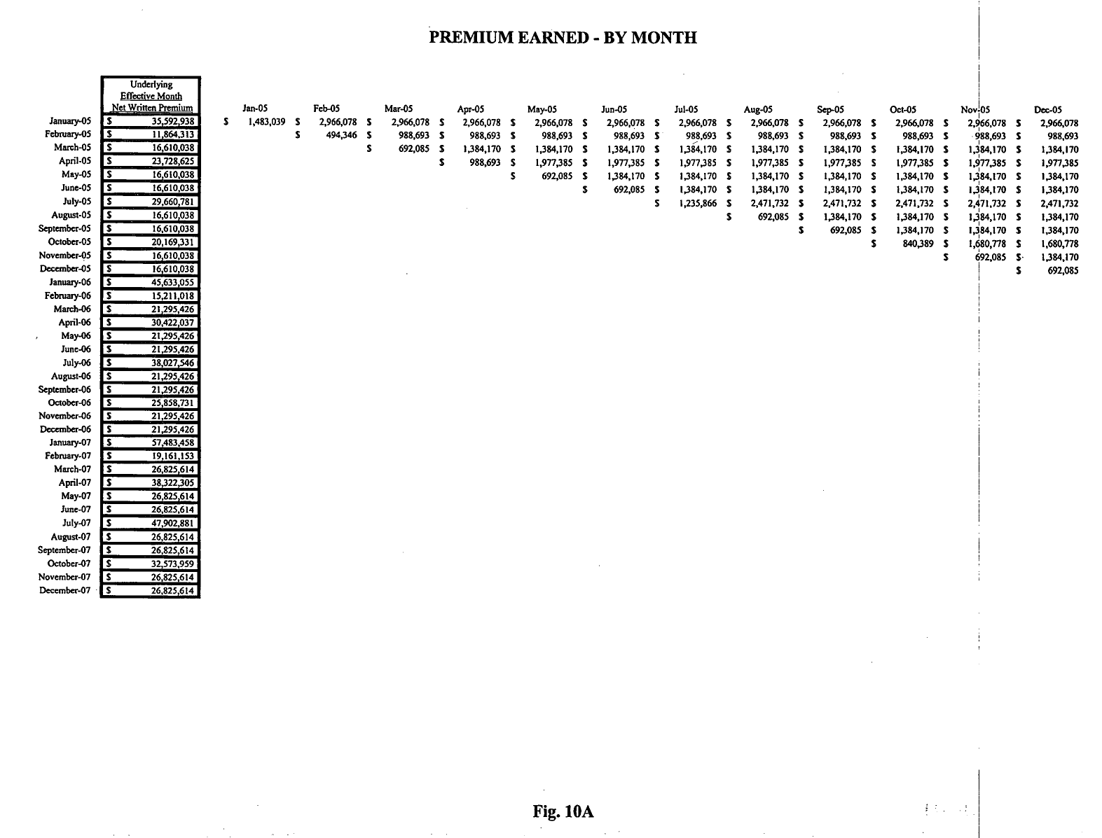

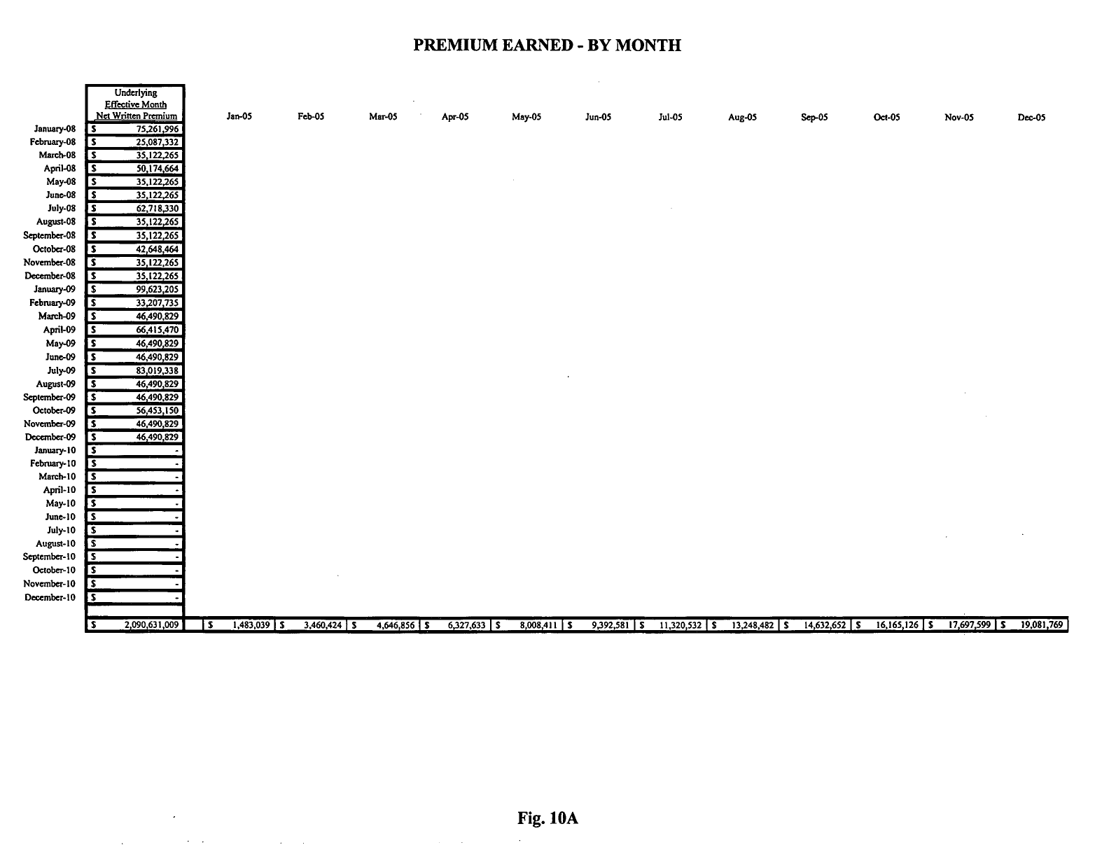

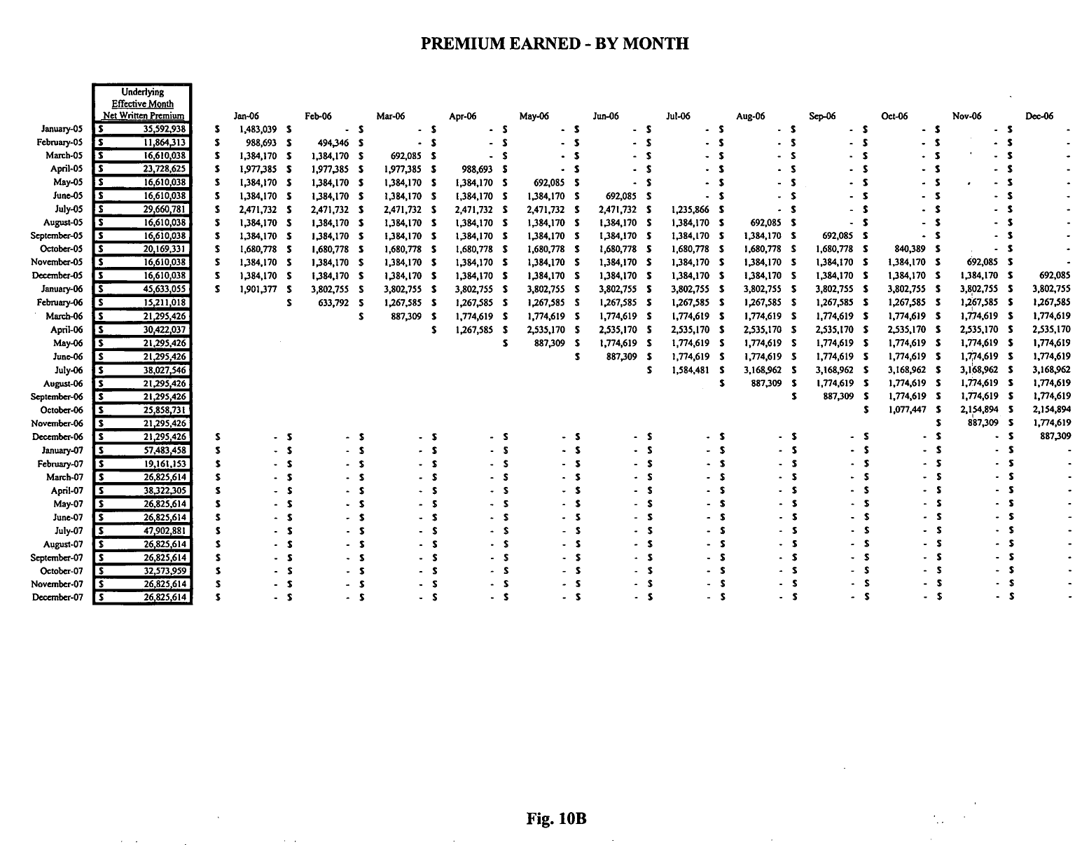

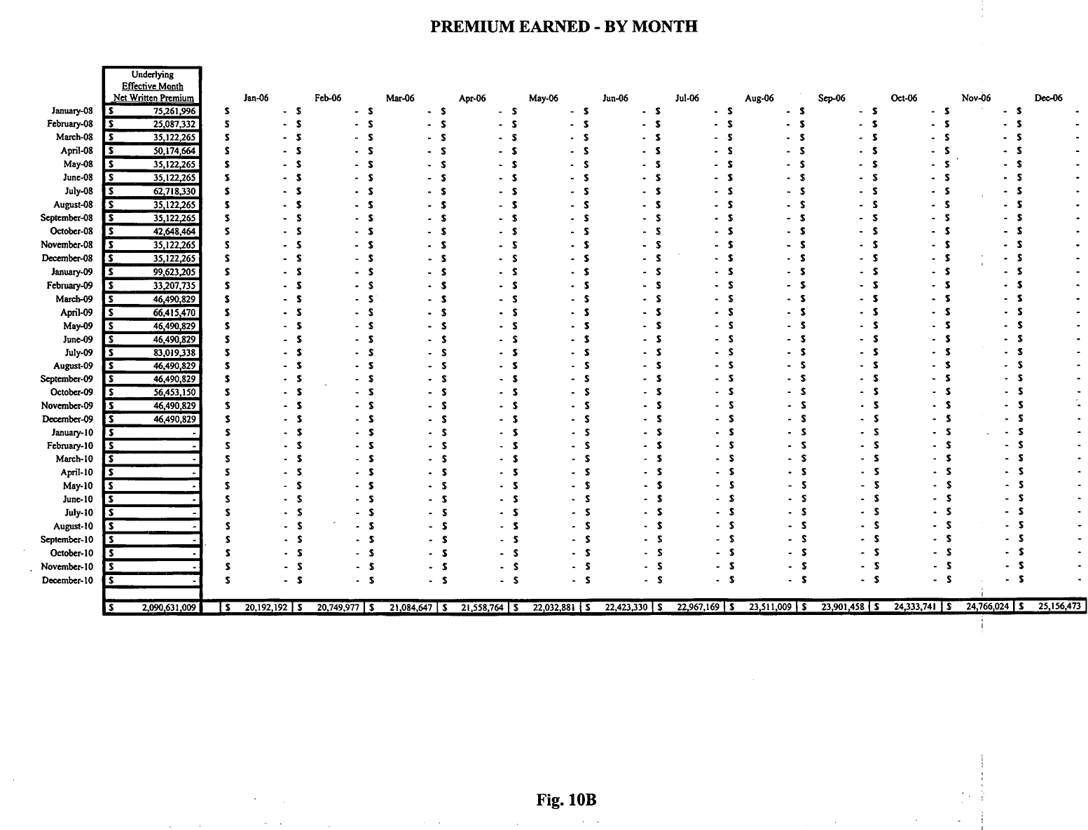

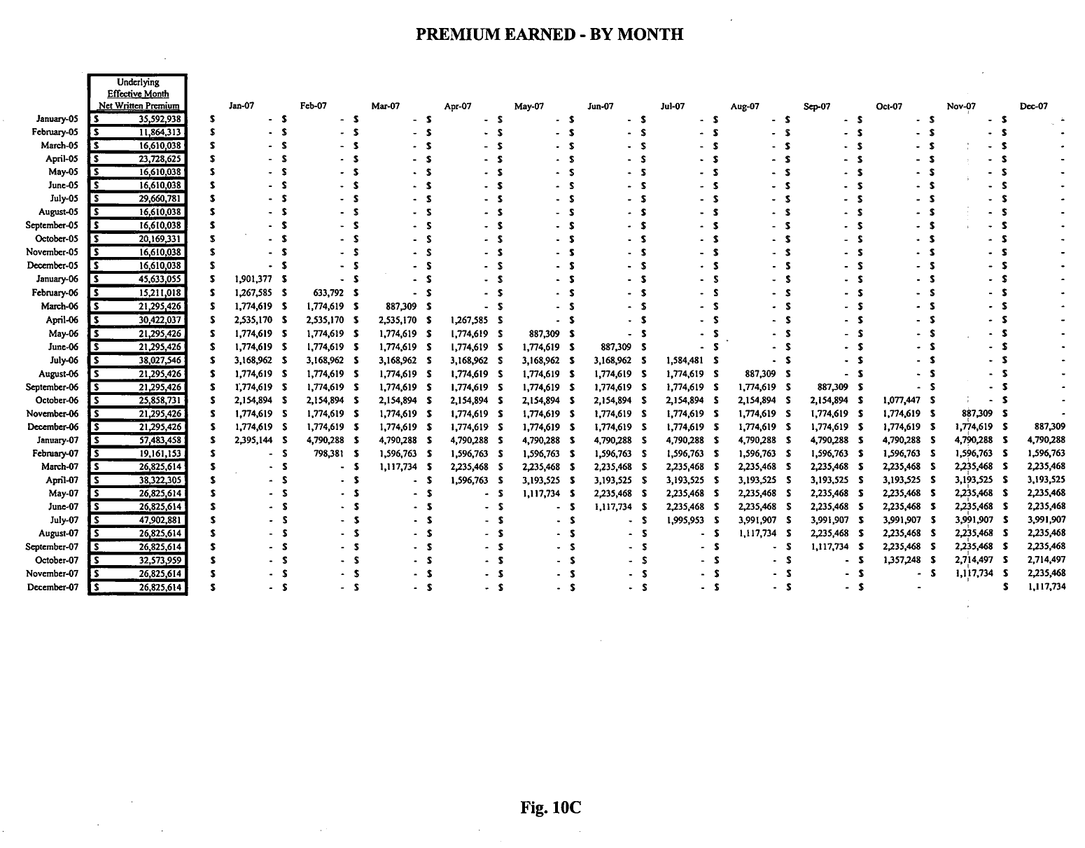

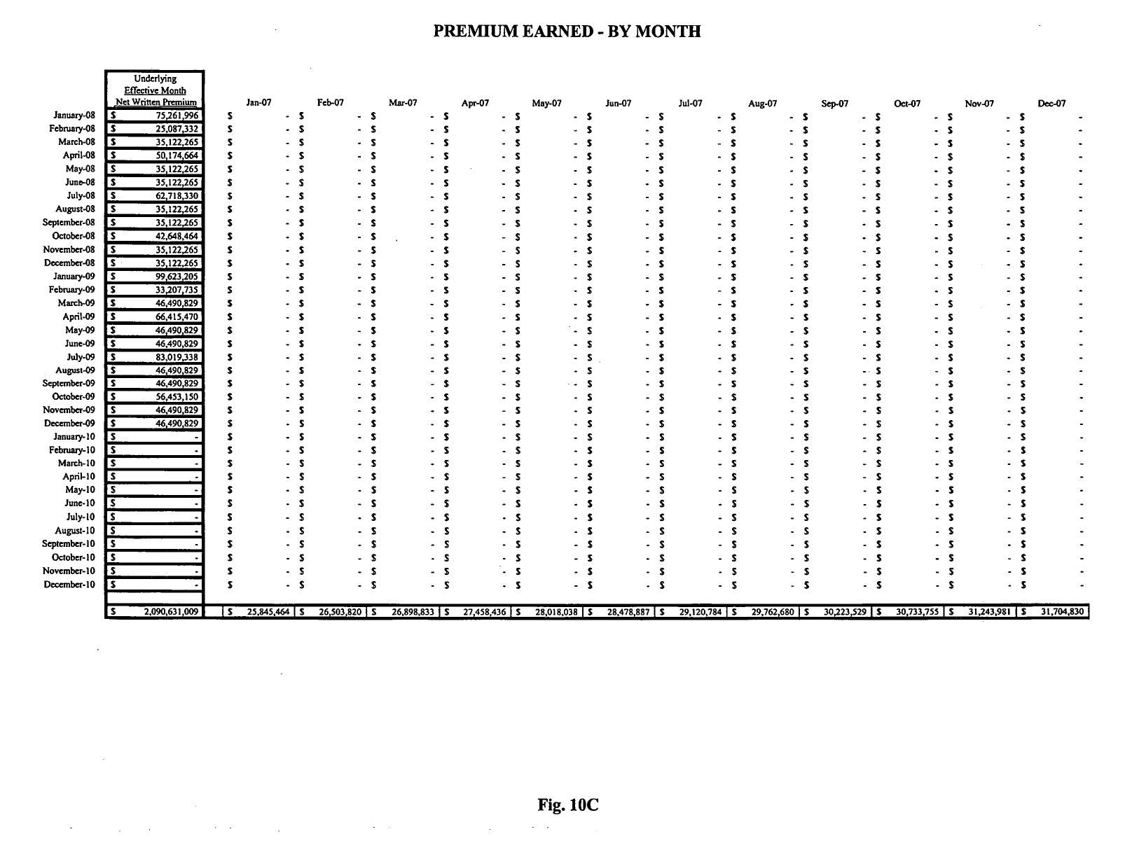

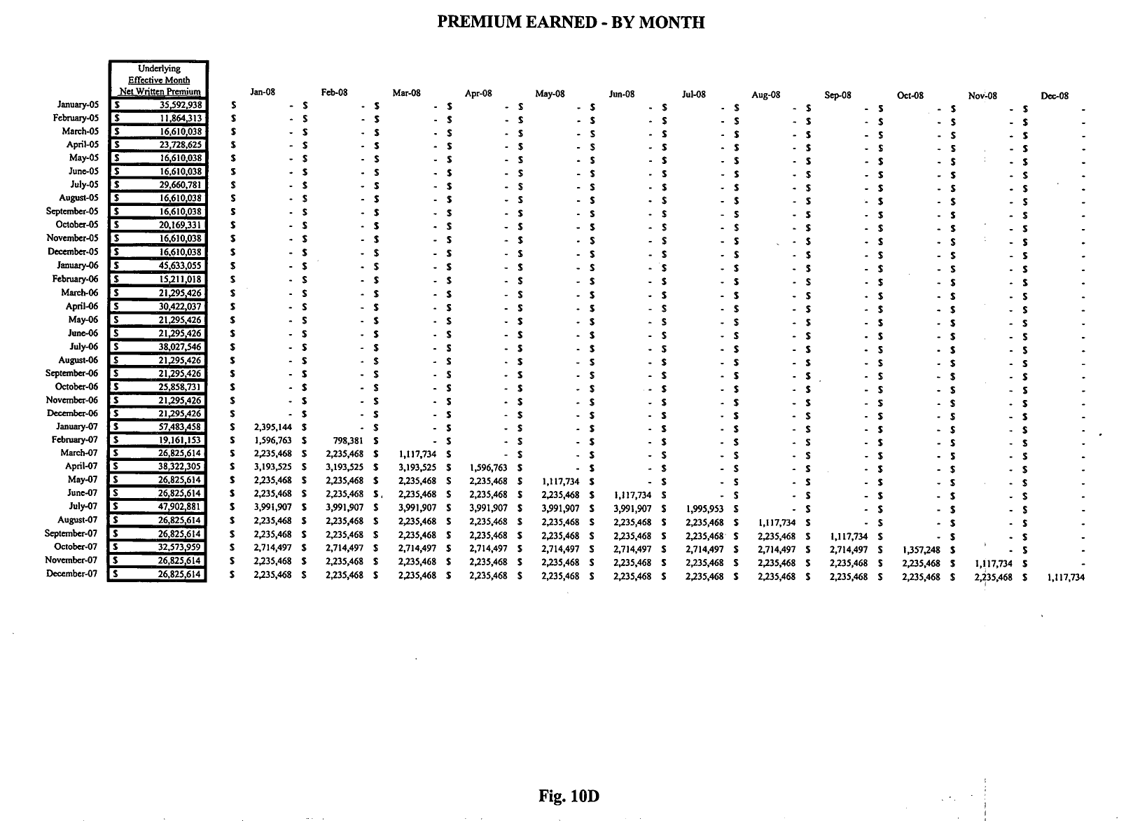

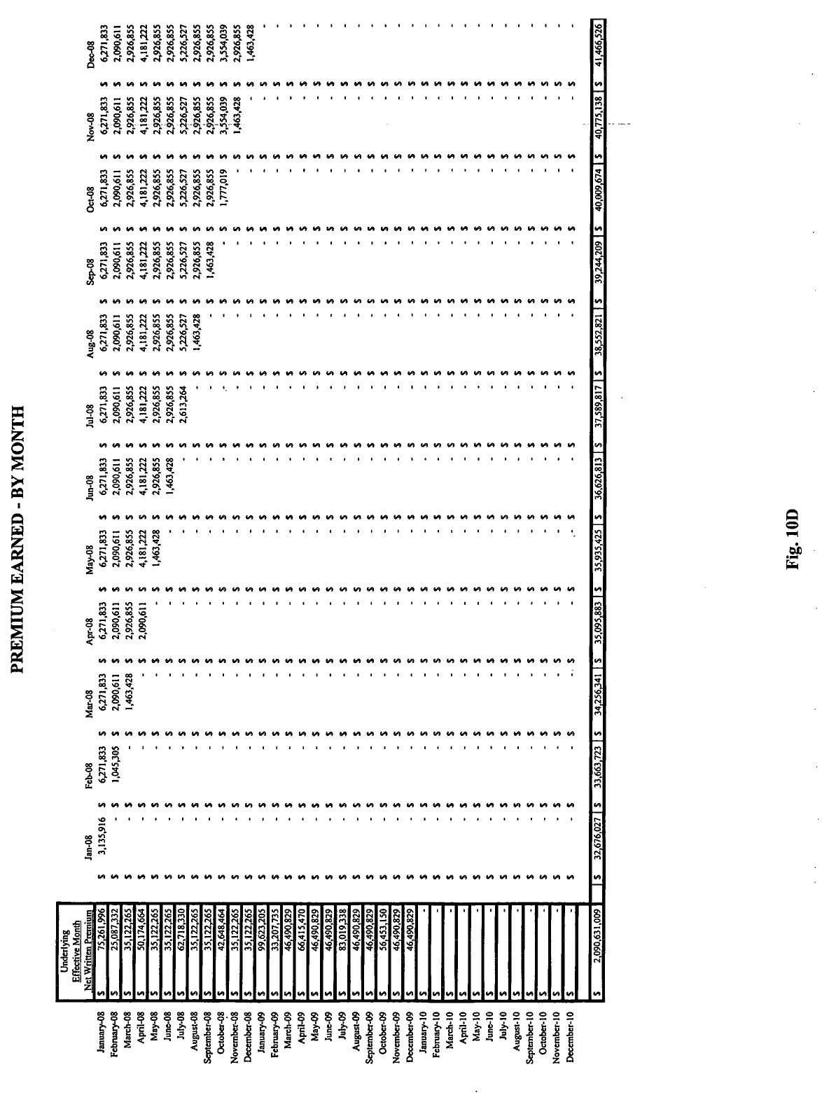

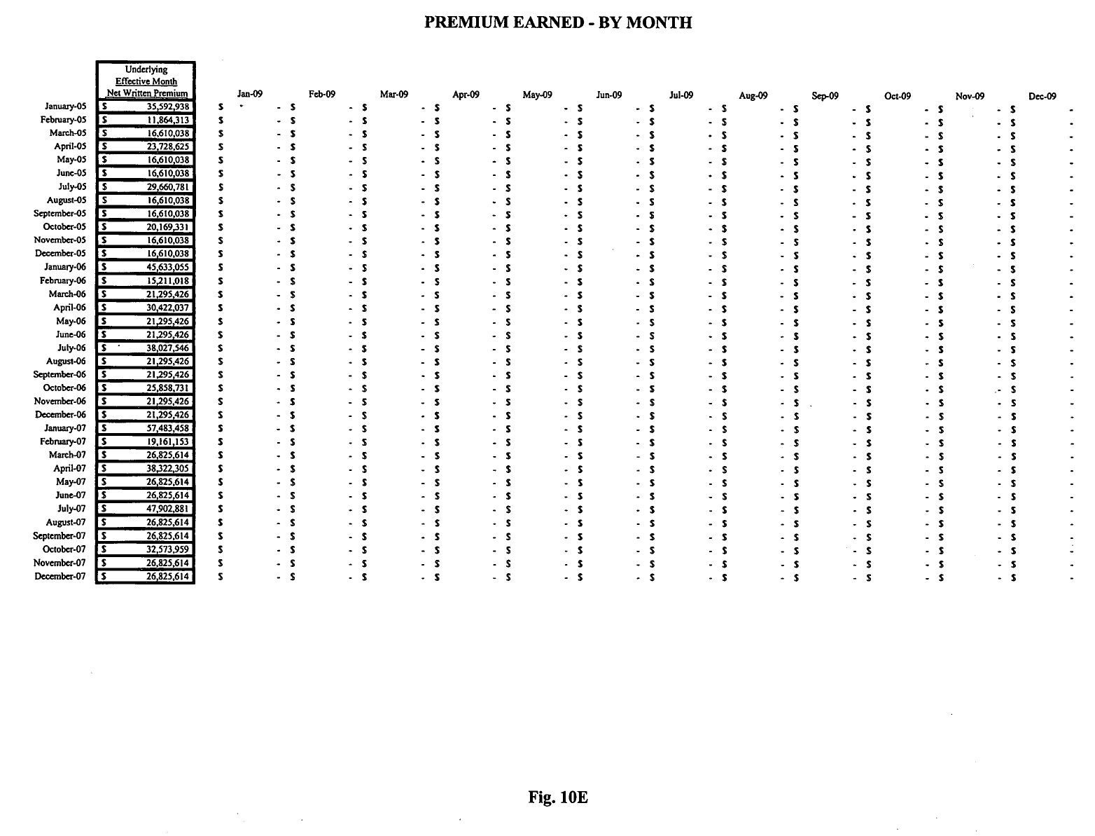

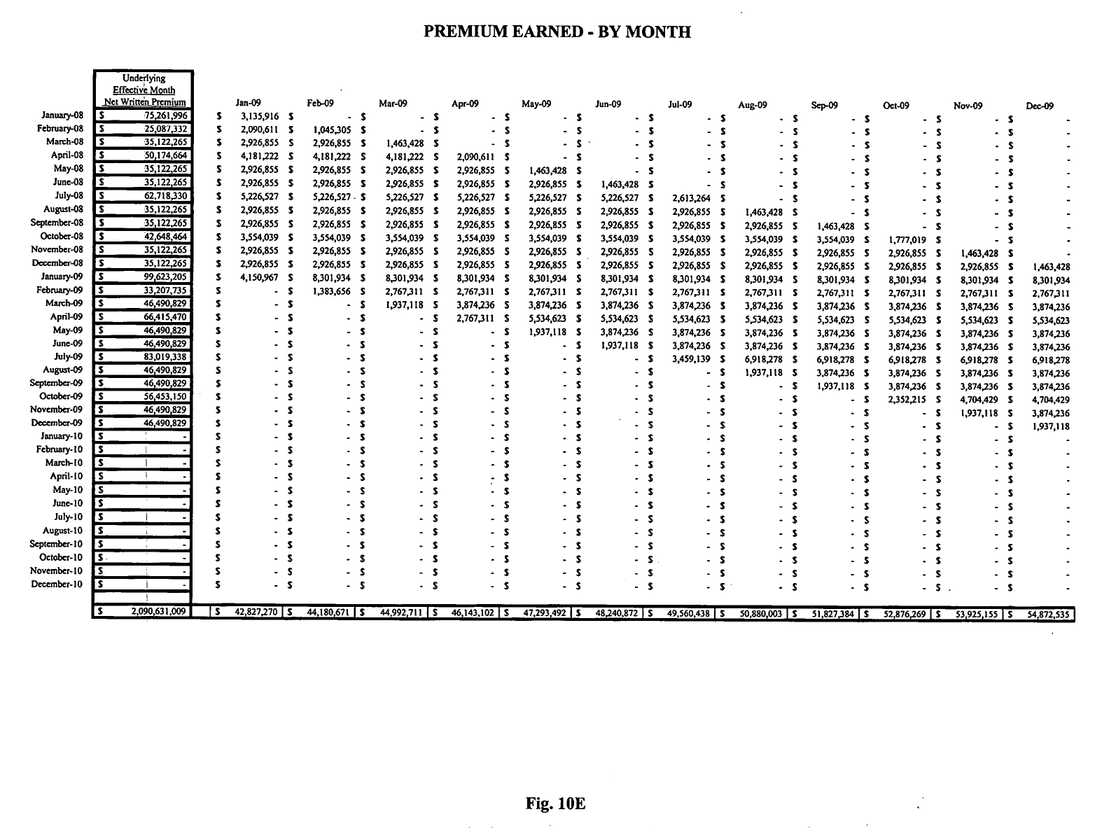

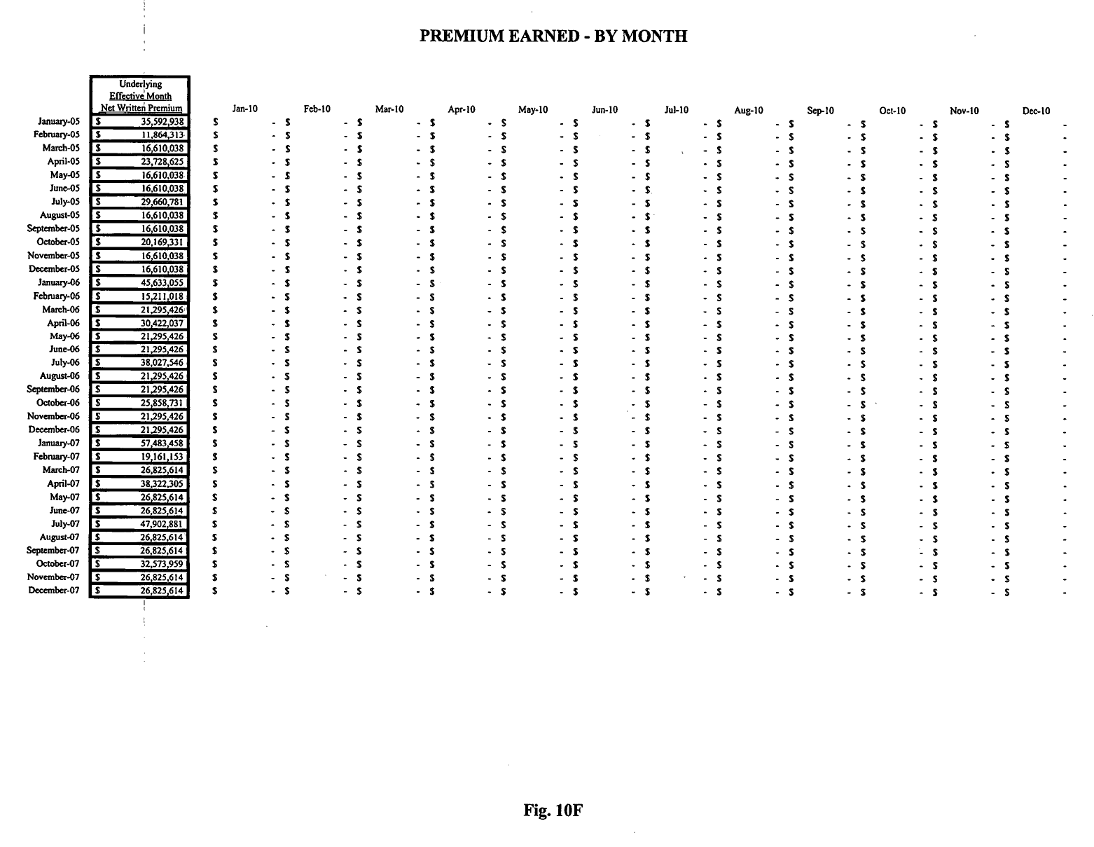

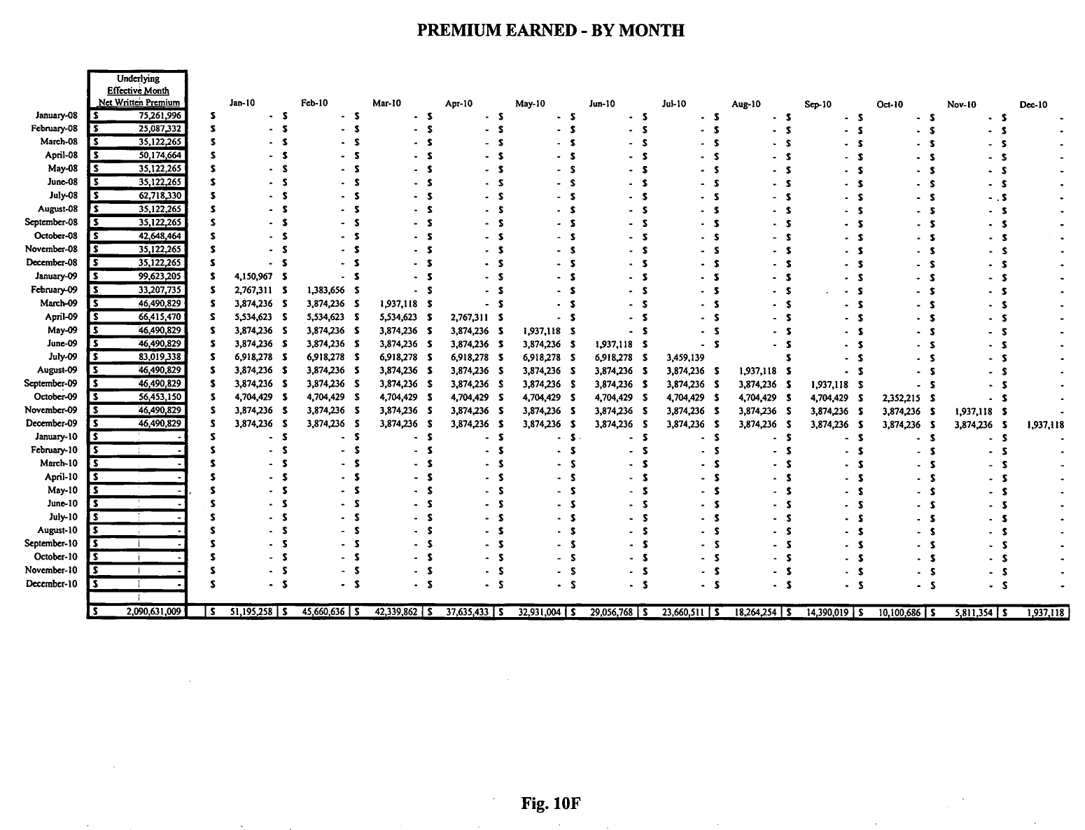

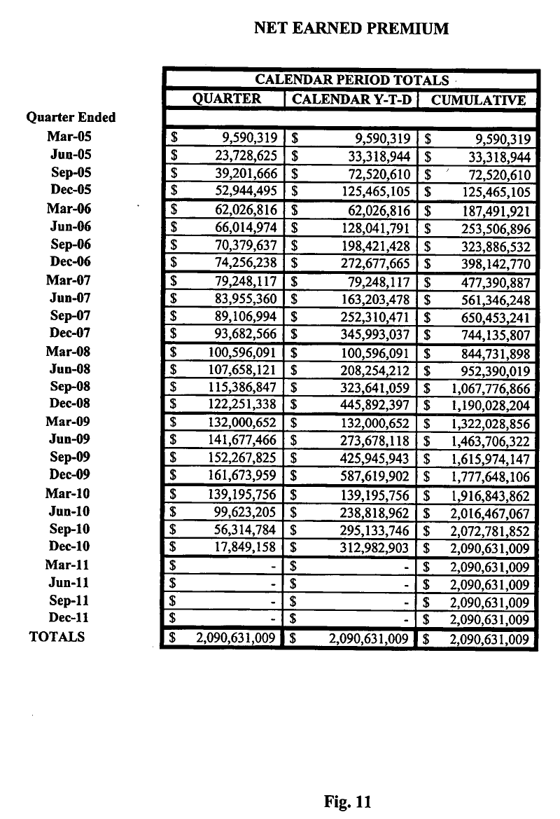

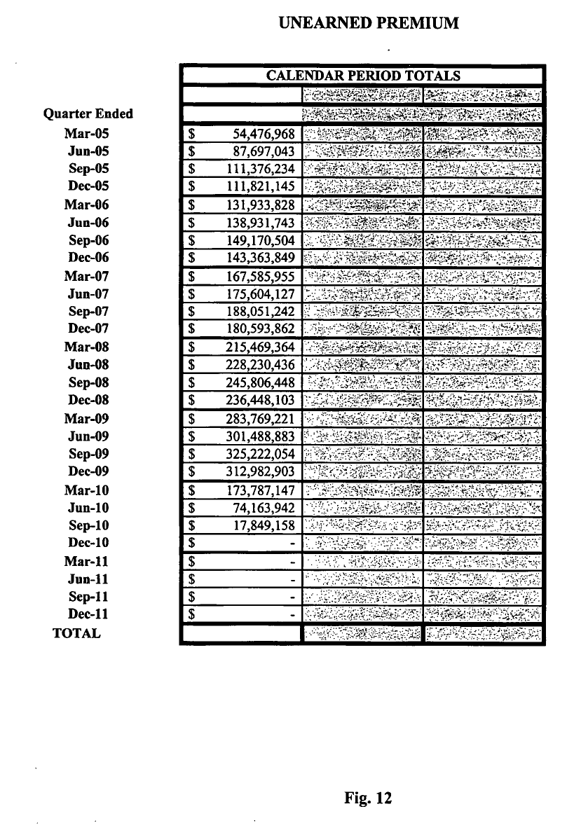

Writing premium is not immediately taken into income by the SPC. According to the accounting method applied by the present model, written premium is earned as the underlying obligations are discharged. Insurance policies and reinsurance treaties are typically written for one year. Premium written on July 1 incurs risk liability that extends through June 30 of the next year. The present model uses straight-line amortization to account for premium that is earned over the course of a year. The total net premium written in a given month is divided into 24 equal parts, of which 1/24th is earned in the month the premium is written on the assumption that the “average” policy is written at mid-month; 2/24ths ( 1/12th) of the total is earned each month thereafter for the next 11 months; and the final 1/24th is earned in the thirteenth month after the premium is written. FIGS. 10A thru F show a schedule of net premium earned each month corresponding to the underlying month in which the premium was written. FIG. 11 shows the total net earned premium by quarter. FIG. 12 shows the remaining written but unearned premium by quarter. Total earned premium is a line item on the income statement (FIG. 5), which amounts to $125,465,105 for 2005. This value can be found in the year-to-date entry for the quarter ending December 2005 in the table shown in FIG. 11. The total written but unearned premium for 2005 is found as the entry for the quarter ending December 2005 in FIG. 12. This amount, $111,821,145, appears as a liability on the Balance Sheet in FIG. 4.

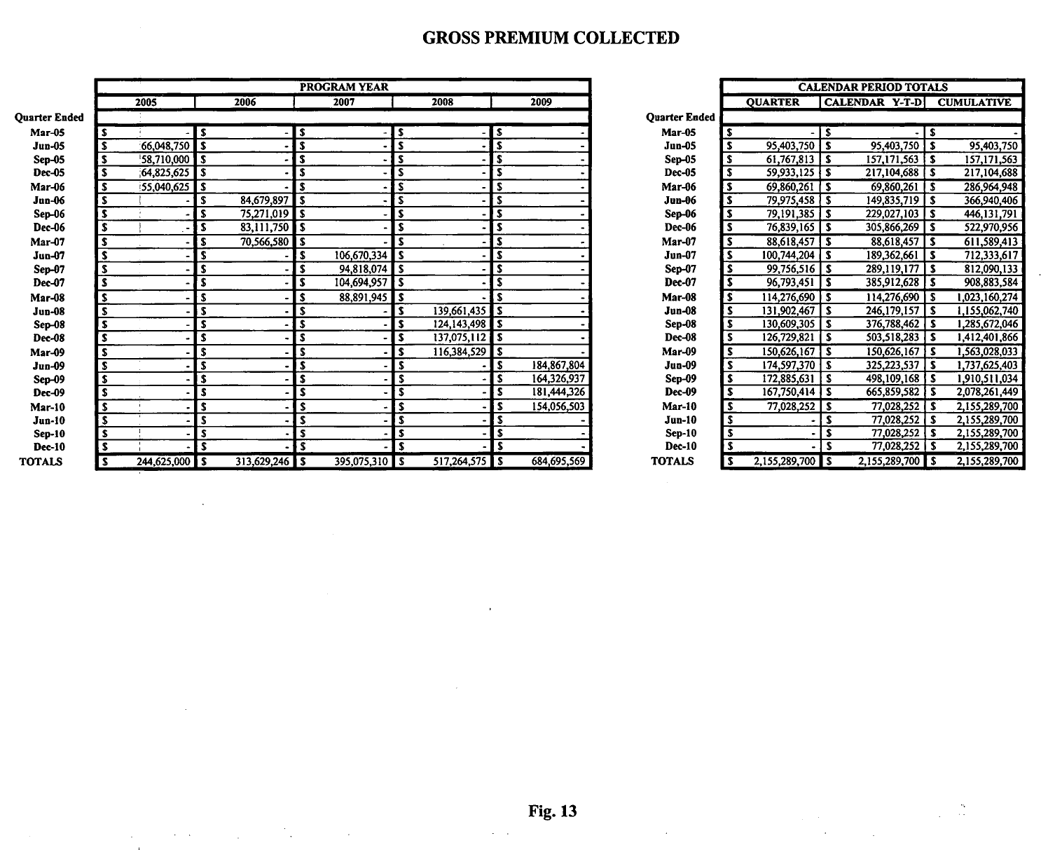

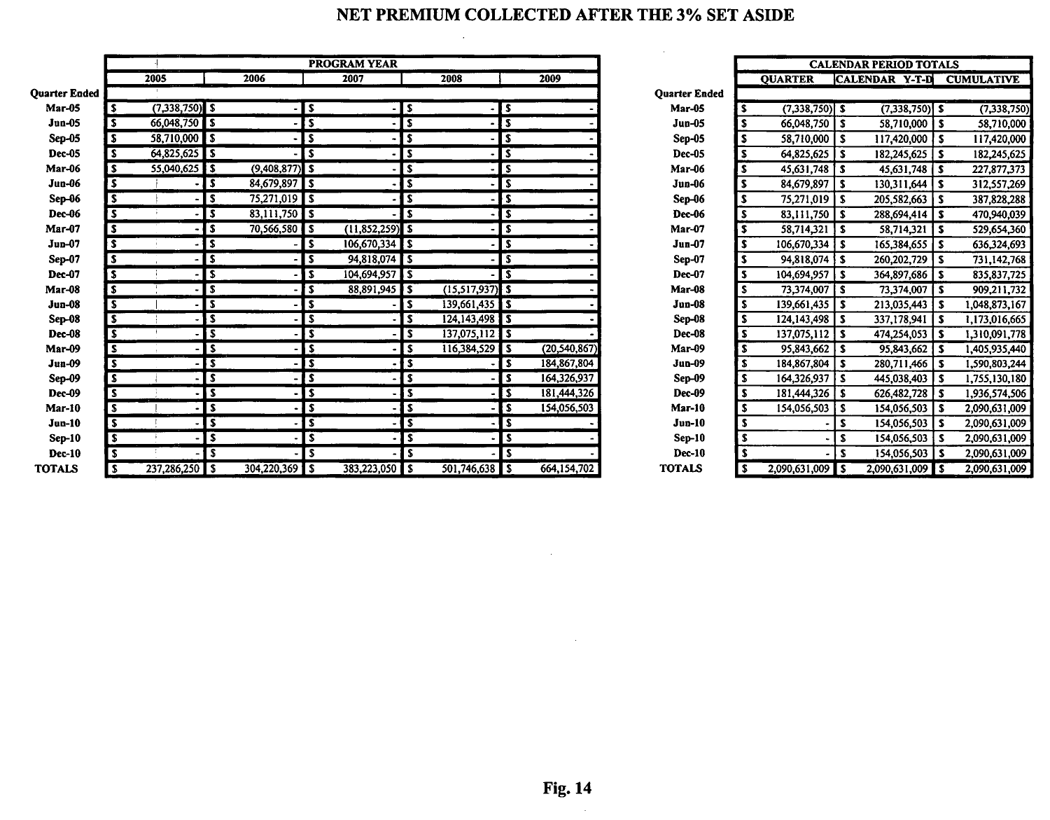

FIG. 13 is a table showing gross premium collected by quarter. The timing of premium collections is important because collections, less loss and expense payments, determine the actual growth of the SPC's funds. The totals for gross premium collected correspond to assumed gross premium written (FIG. 9), except that each entry is offset by one calendar quarter because collections are delayed 45 days from the time the written premium is booked. Premium written in the first half of a quarter will be collected in the same quarter, whereas premium written in the second half of the quarter will be collected in the next quarter. Accordingly, comparing the table in FIG. 13 to that in FIG. 7, we see that the $66,048,750 of assumed gross premium written in the quarter ending March 2005 is booked as being collected in the quarter ending June 2005. Similarly, the $58,710,000 of assumed gross premium written in the quarter ending June 2005 is booked as being collected in the quarter ending September 2005 and so forth. The quarterly, year-to-date, and cumulative totals are adjusted to reflect the 45 day delay in premium collections. FIG. 14 is a table similar to the table in FIG. 13 except that FIG. 14 shows net collections by quarter after the 3% setaside reinsurance-to-close has been subtracted.

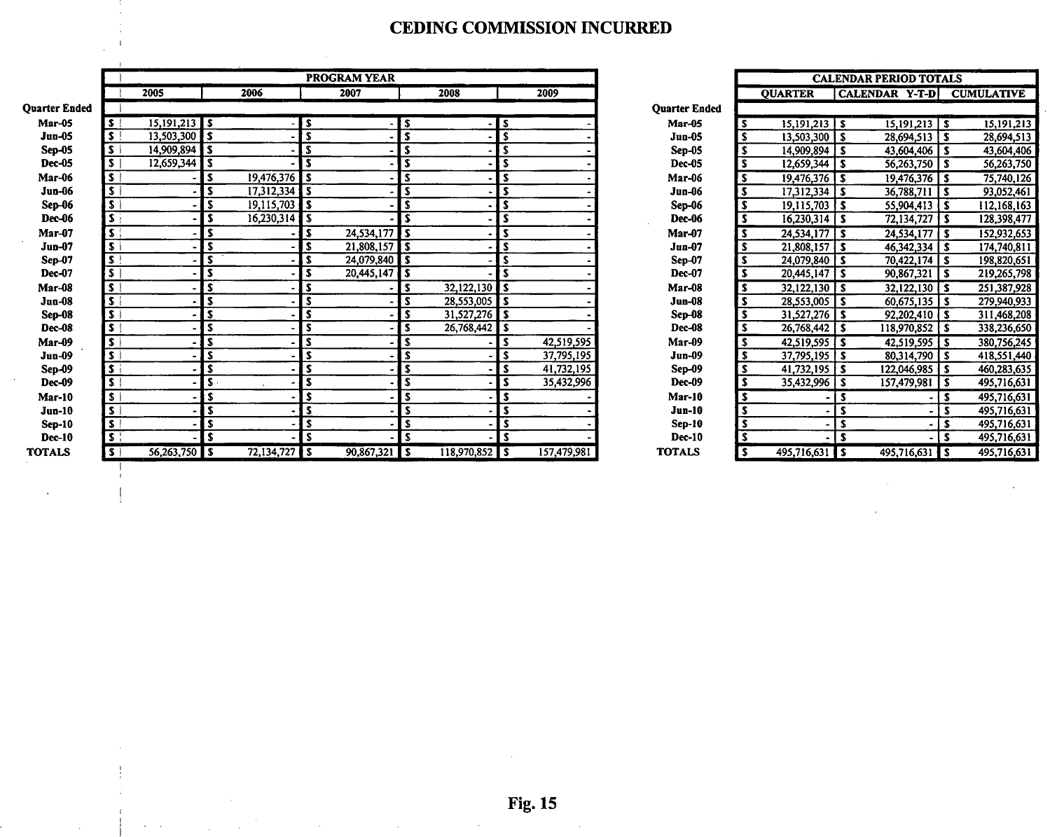

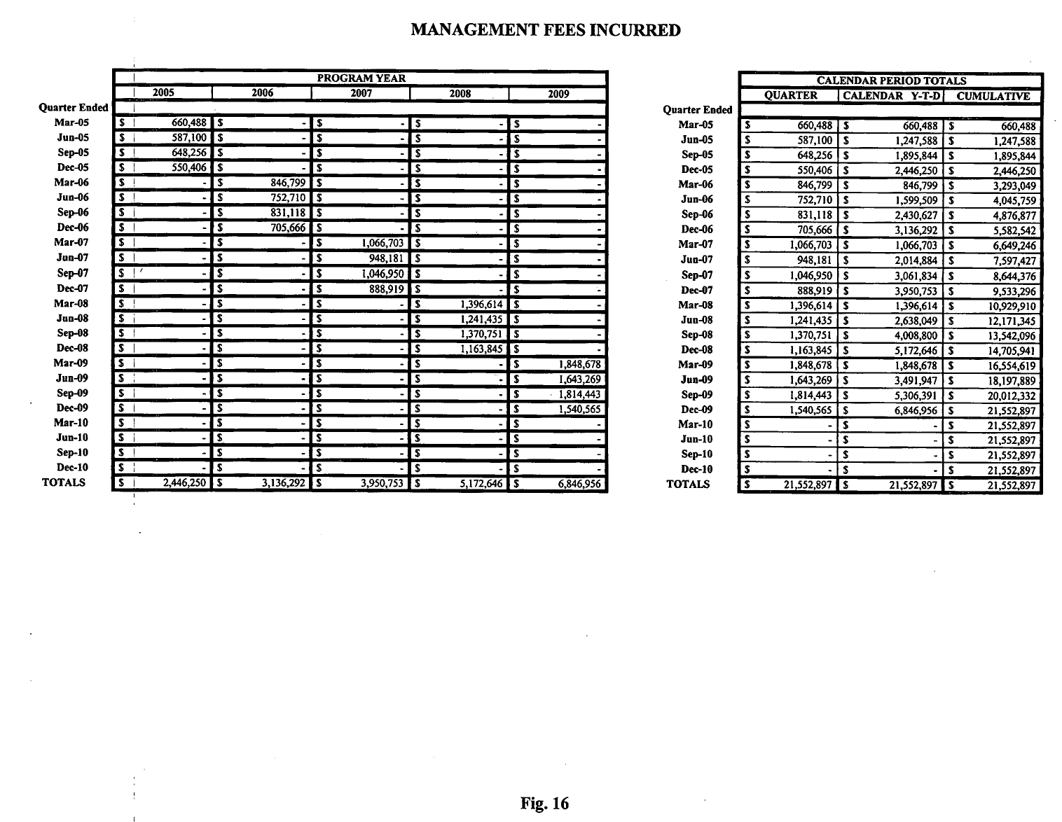

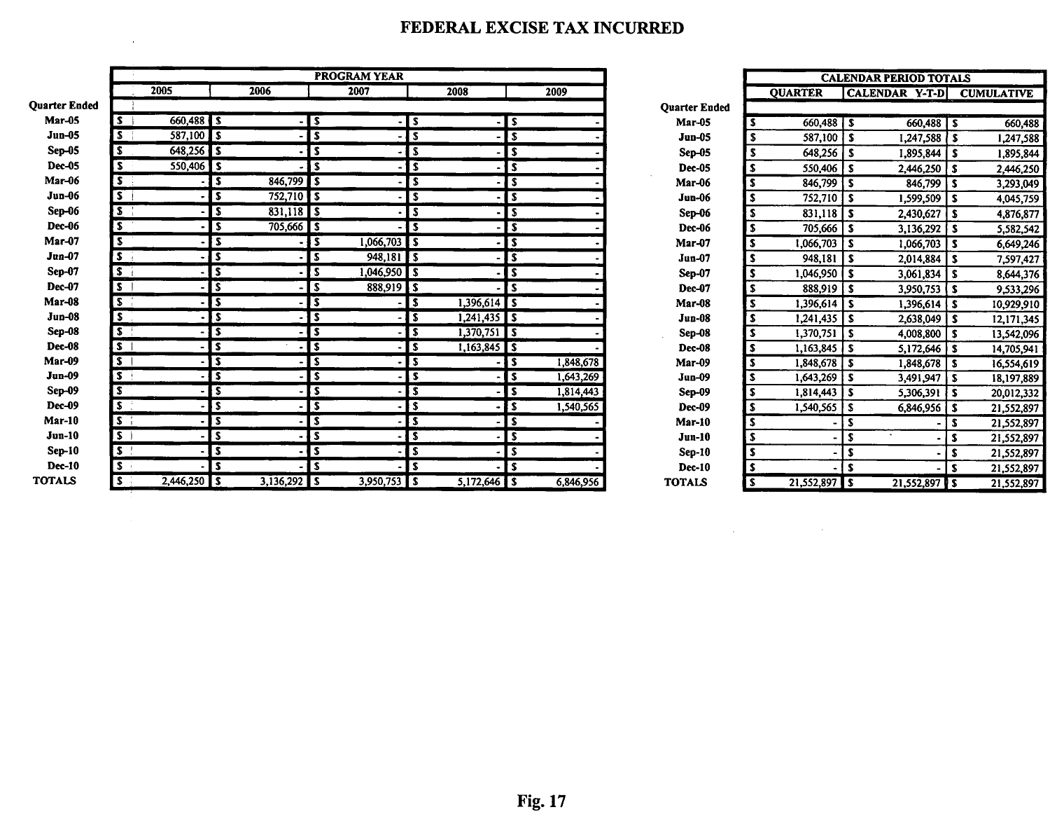

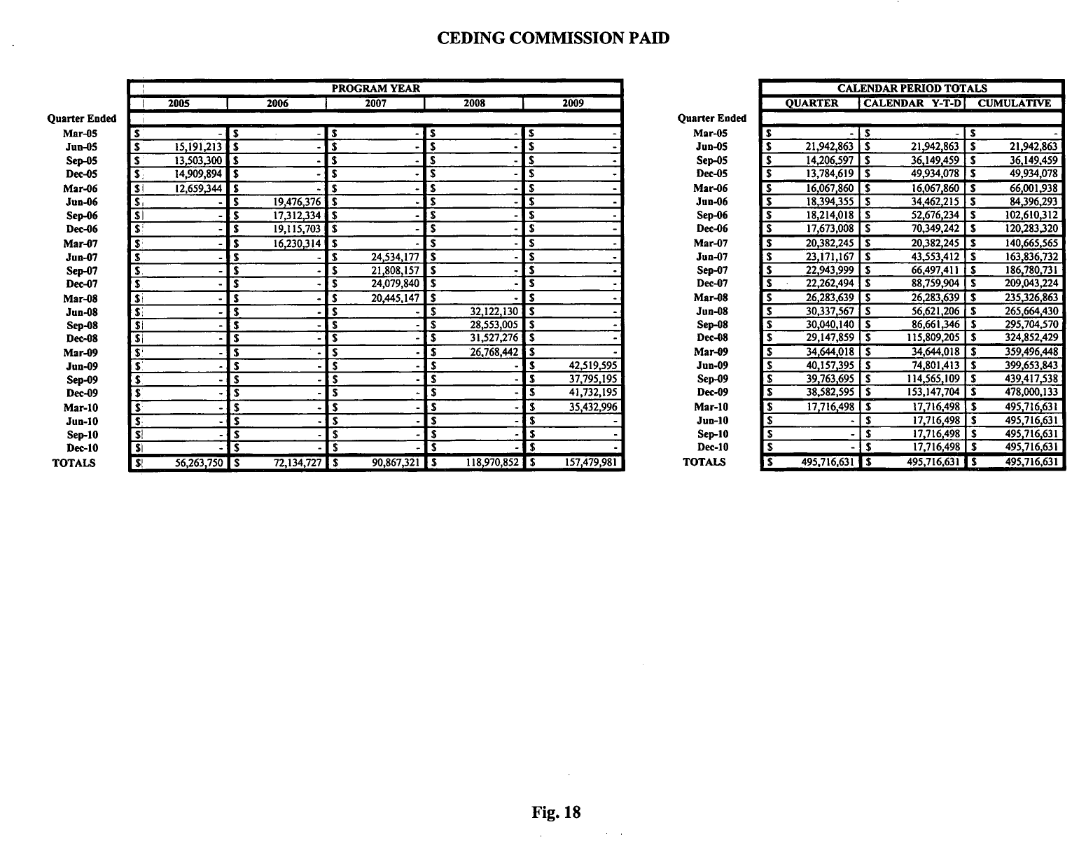

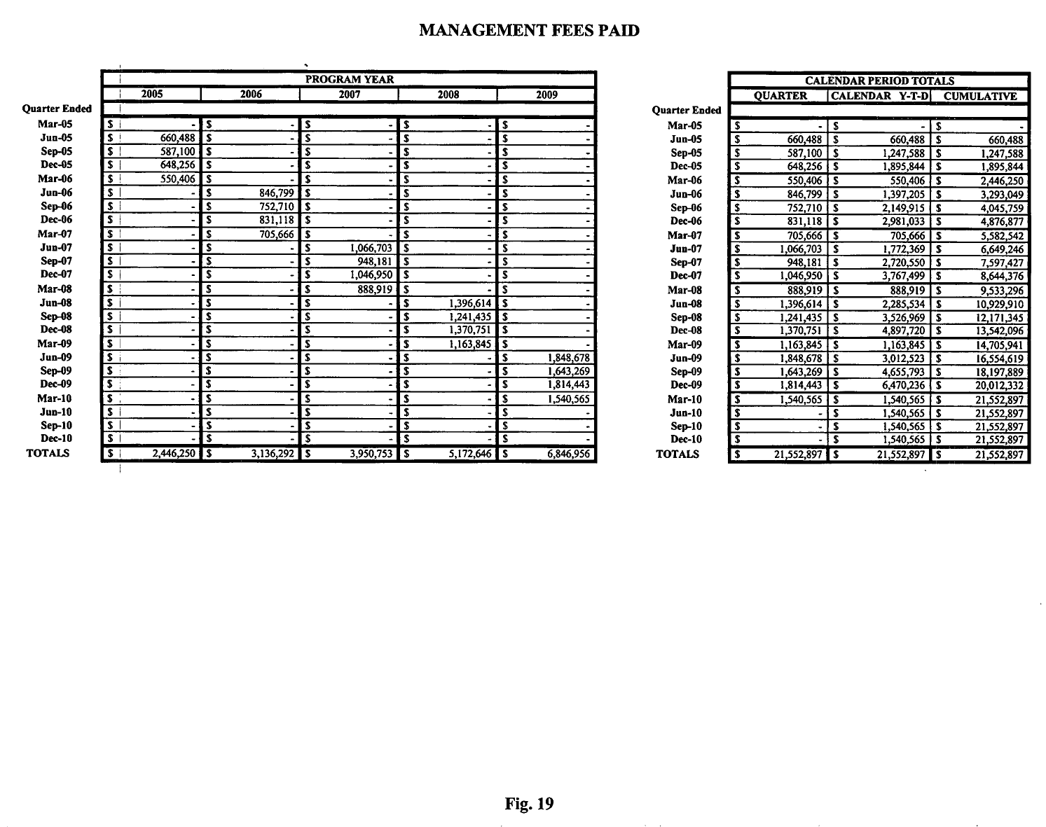

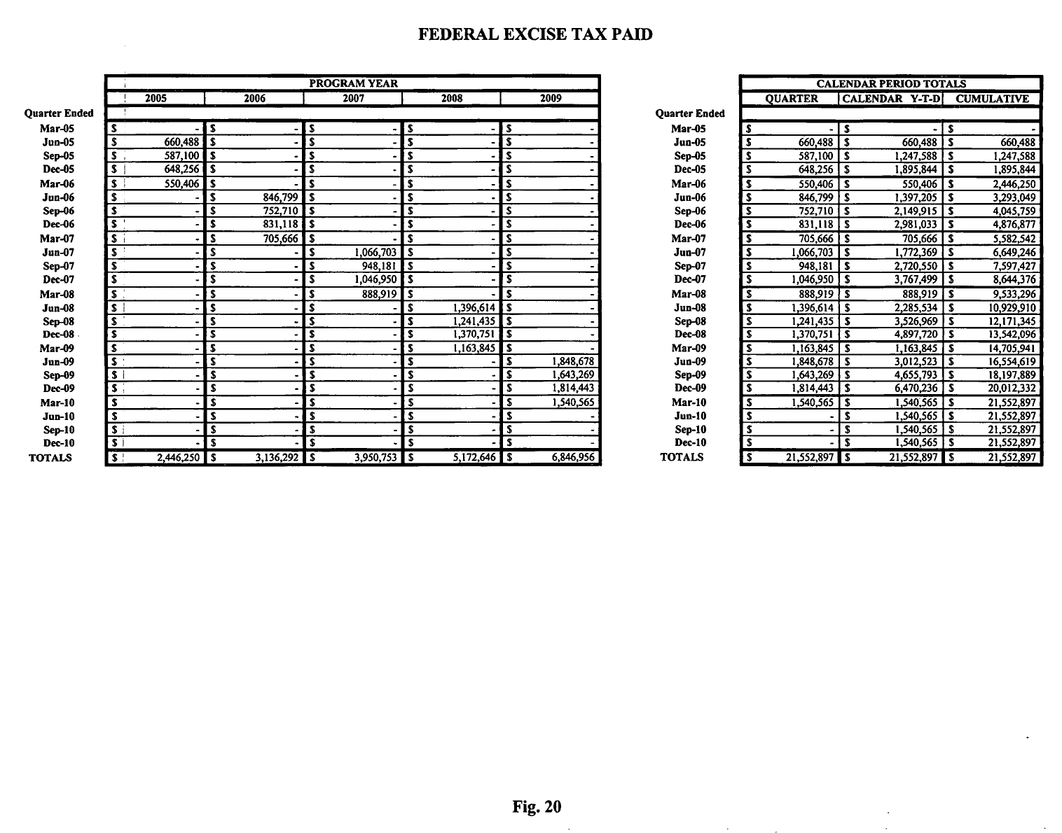

Operating expenses and loss payouts also impact the growth of the surplus. According to the present model, the SPC's operating expenses include 23% ceding commission, a 1% annual management fee, and a 1% Federal excise tax, all measured by gross premium. These expenses are booked in the same quarter in which the underlying gross premium is written. FIG. 15 is a table showing ceding commission incurred each quarter; FIG. 16 is a table showing management fees incurred; and FIG. 17 is a table showing Federal excise tax incurred. Each of the tables in FIGS. 15, 16 and 17 are by calendar quarter. The model assumes that ceding commission, management fees and Federal excise tax will be paid the quarter after they are incurred. Accordingly, FIG. 18 is a table showing ceding commission paid; FIG. 19 is a table showing management fees paid; and FIG. 20 is a table showing Federal excise tax paid.

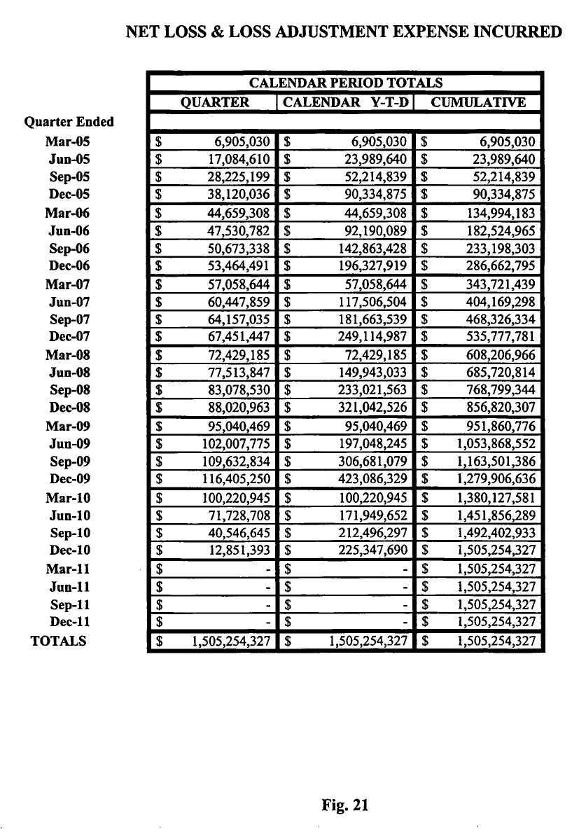

In addition to premium collections and operating expenses, the growth of the SPC's funds also depends on payouts of incurred losses. When such losses occur and when they are paid have a major effect on cash flow, and therefore on the growth of the SPC's net worth. As shown in FIG. 3, the present model assumes a 72% loss ratio. The model further assumes that losses will be incurred in the same quarter the associated premium is earned. Accordingly, the incurred losses and LAE amount to 72% of the net premium earned in the same quarter. FIG. 21 is a table that shows losses and LAE incurred each quarter. Each quarterly entry corresponds to 72% of the net earned premium for the same quarter as set out in the table shown in FIG. 11.

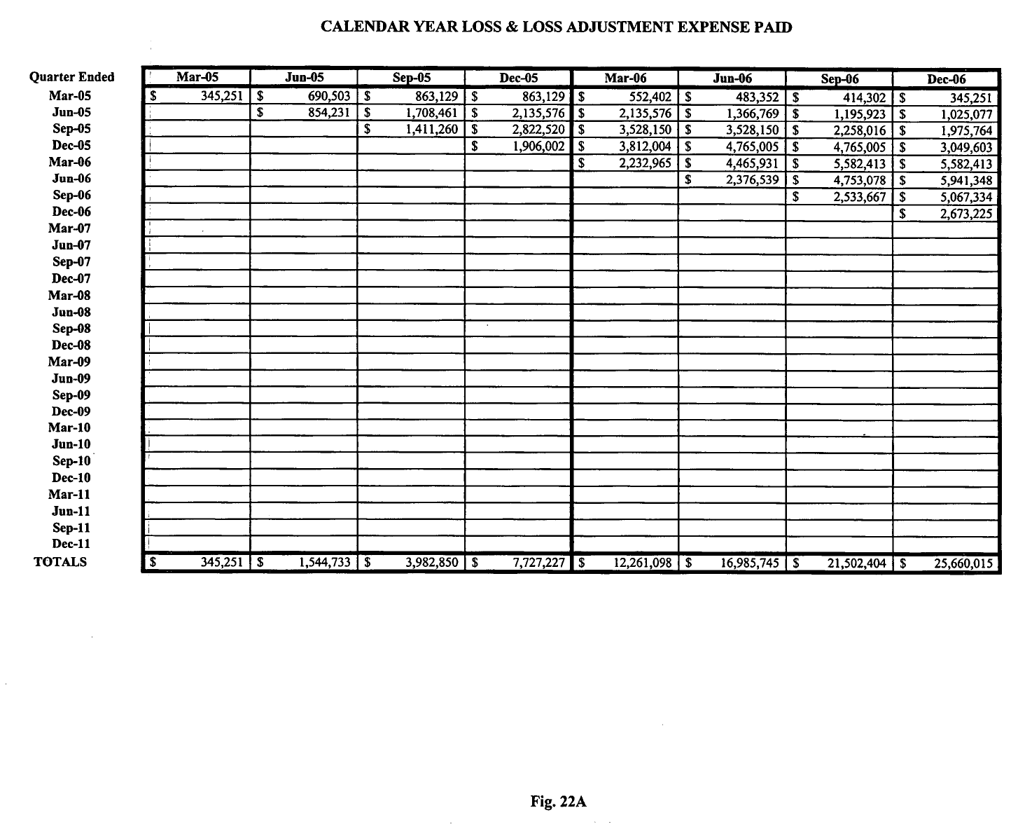

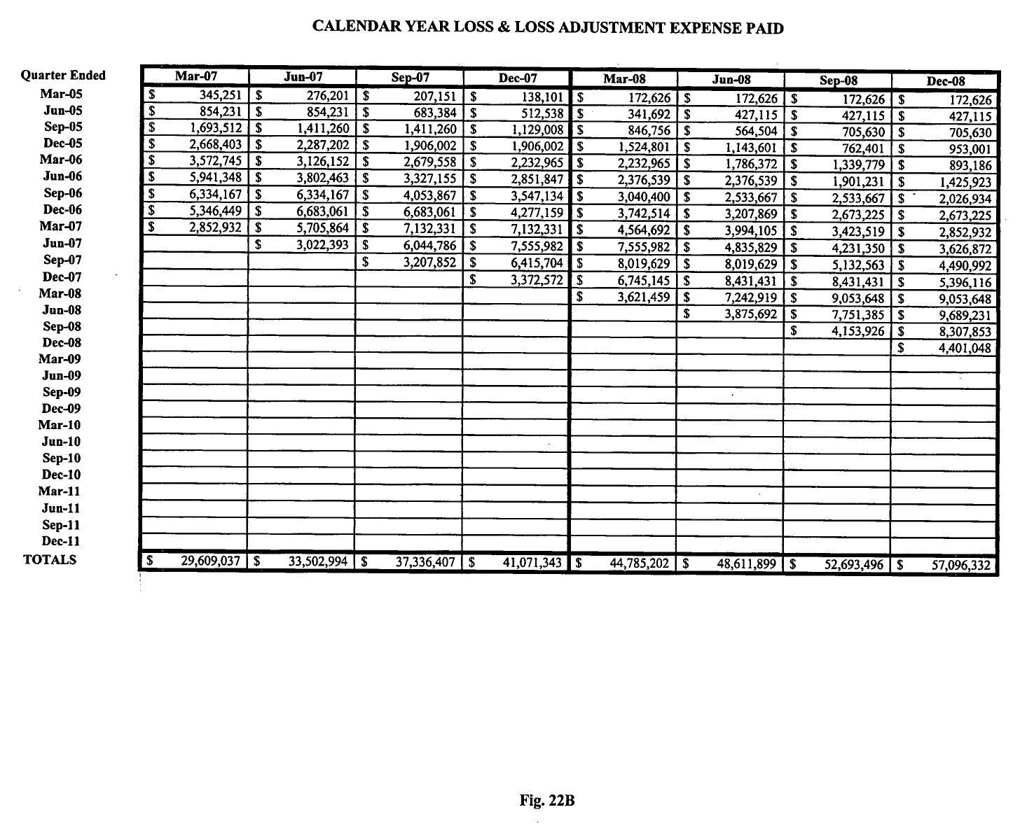

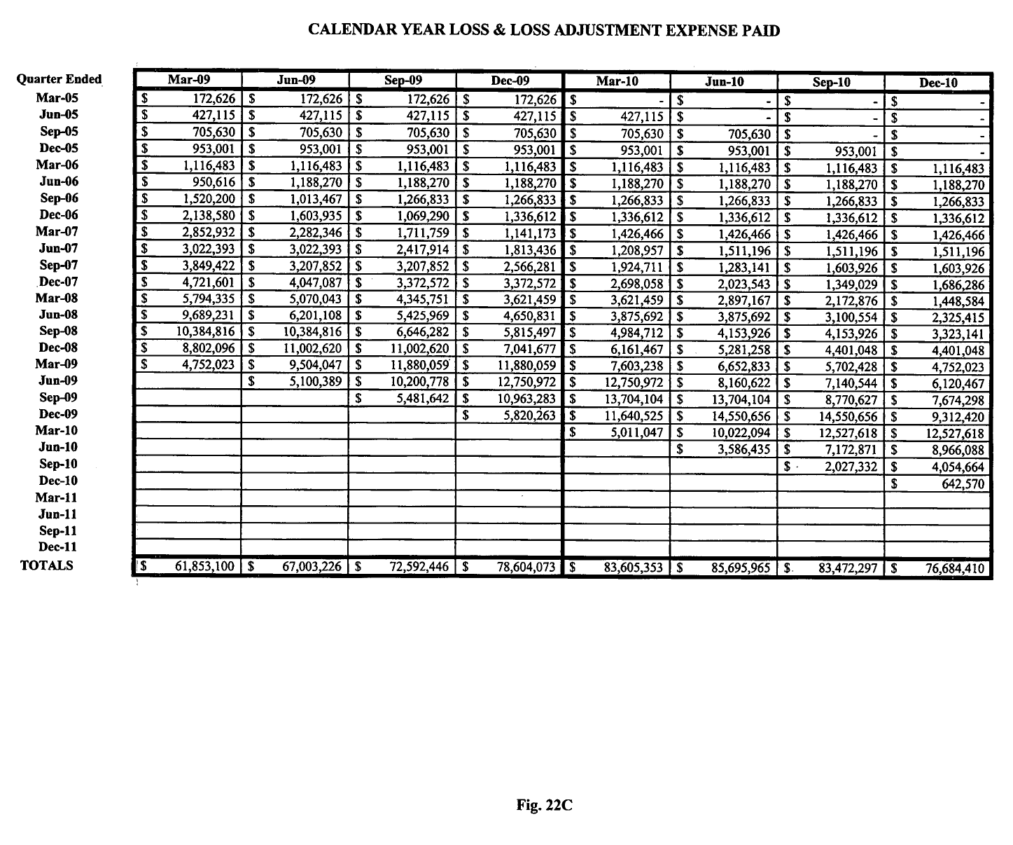

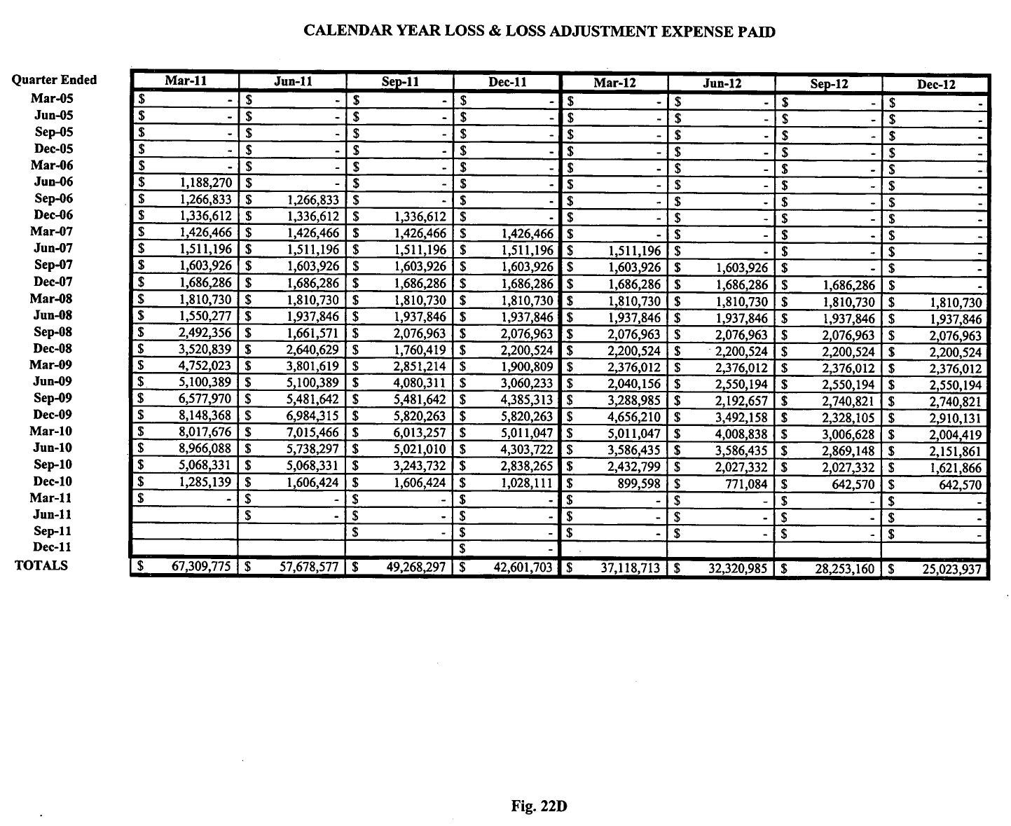

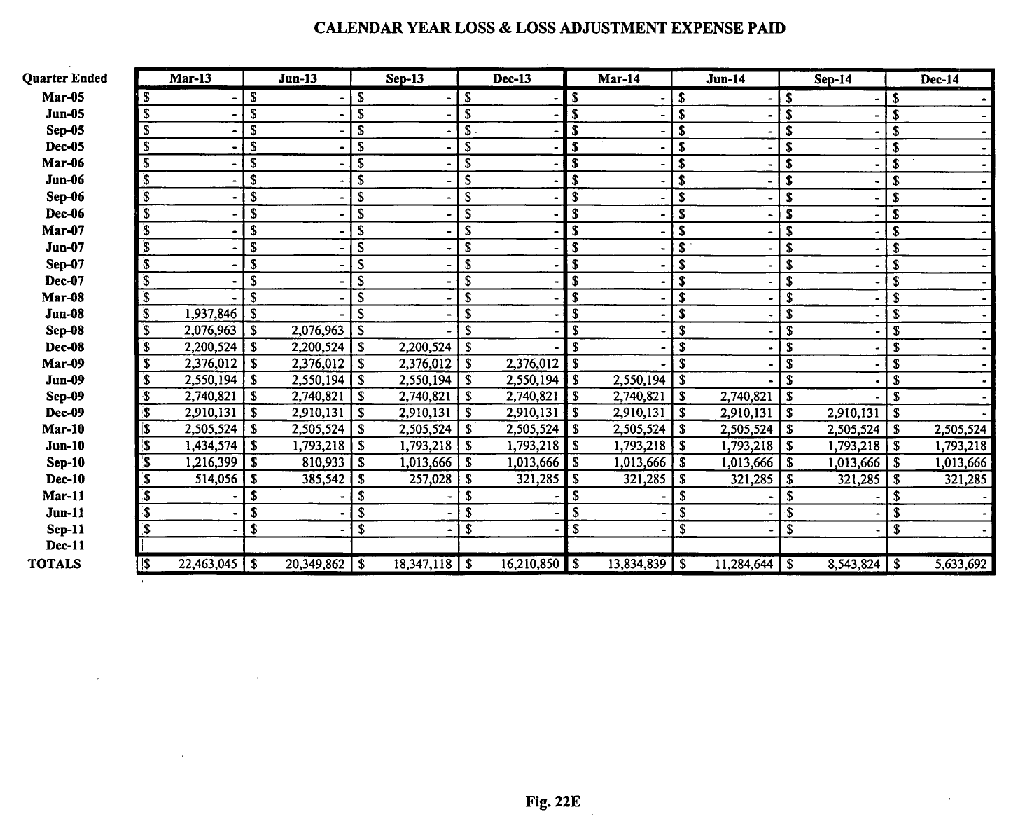

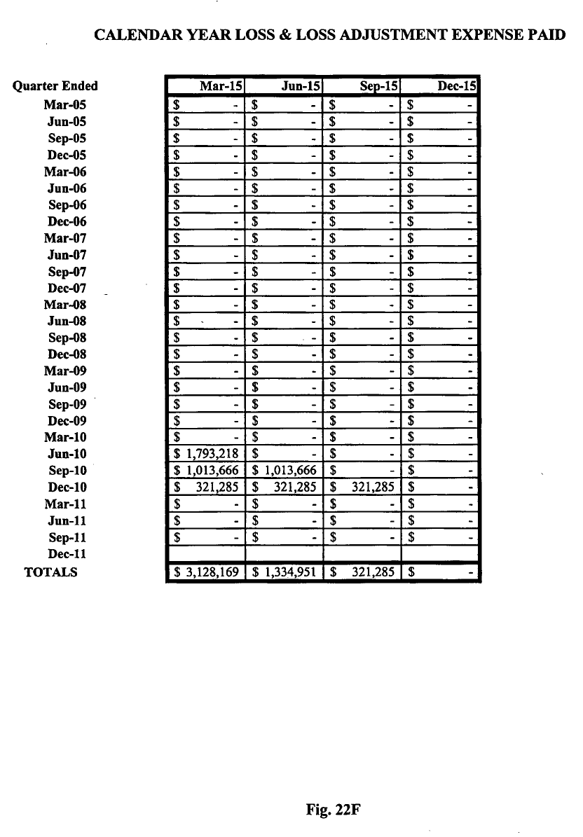

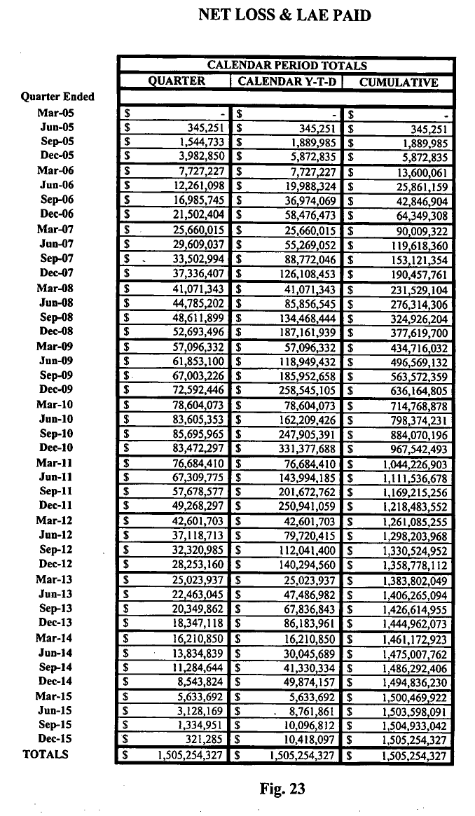

Although losses and LAE are deemed incurred in the same quarter the associated premium is earned, actual payment is later. Reporting delays, claim adjusting procedures, reinsurance notification requirements, and other factors will delay the time at which losses are actually paid. A schedule of loss payouts is shown in FIG. 3. According to the model, payouts for losses incurred in a given quarter will be spread out over the next twenty quarters. Of these losses and LAE, 5% will be paid out the first quarter in which the loss occurs, 10% will be paid out the second quarter, 12.5% the third quarter, and so forth according to the schedule. FIGS. 22A thru F show a loss payout schedule for losses incurred each quarter. Working forward from the table in FIG. 11, net earned premium for the quarter ending March 2005 is $9,590,319. From the table in FIG. 21 net losses and LAE accruing that same quarter is $6,905,030 (i.e., 72% of $9,590,319). From the schedule shown in FIGS. 22A, $345,251 of this total (5%) is paid out in the quarter ending March 2005, and $690,503 (10%) is paid in the quarter ending June 2005. Such payments continue through the quarter ending December 2009 according to the loss payout schedule of FIG. 3. Adding all the values in the first row to be checked of the loss and LAE payment schedule horizontally, 6,905,030 or 100% of the losses and LAE incurred in the quarter ending March 2005 are paid out by the quarter ending December 2009 (FIGS. 22A and B). The total losses paid out each quarter are determined by adding the columns of the schedule in FIGS. 22A thru C vertically. This shows that the total net loss and LAE payouts for the quarter ending March 2005 are $345,261. Payouts for the quarter ending June 2005 are $1,544,733 and so forth. Total quarterly net losses and LAE payouts are tabulated in FIG. 23.

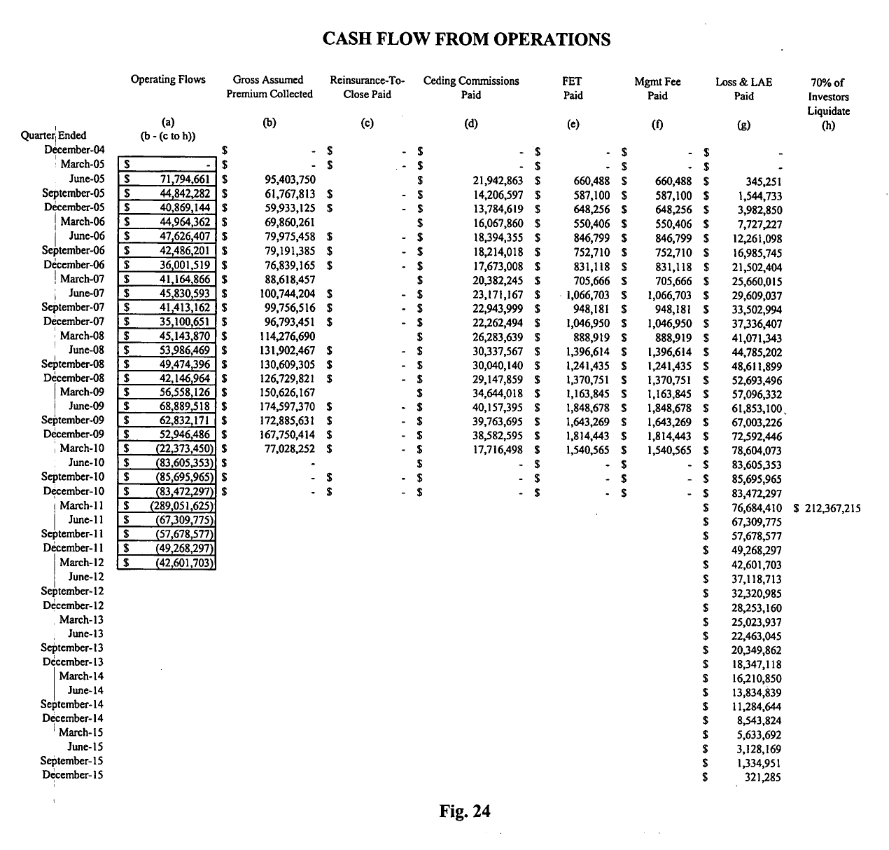

With the schedules of quarterly premium collections (FIG. 14), losses and LAE payments (FIG. 23) and other expenses (FIGS. 18, 19 and 20) are consolidated in the table in FIG. 24, which shows quarterly cash flows from operations. For the quarter ending June 2005, $95,403,750 of gross premium is collected (FIG. 13). For the same quarter, $21,942,863 of ceding commission is paid (FIG. 18); $660,488 in Federal excise taxes are paid (FIG. 19); $660,498 in management fees are paid (FIG. 20); and $345,251 in losses and LAE are paid (FIG. 23). These collections and payments result in a net cash inflow from operations of $71,794,661 for the quarter ending June 2005. Similar calculations show a cash inflow of $44,842,282 for the quarter ending September 2005, $40,869,144 for the quarter ending December 2005, and so forth. In the year 2010, after the SPC has ceased writing additional premium, the cash inflow switches to outflow as losses and expenses continue to be paid while no additional premium is collected.

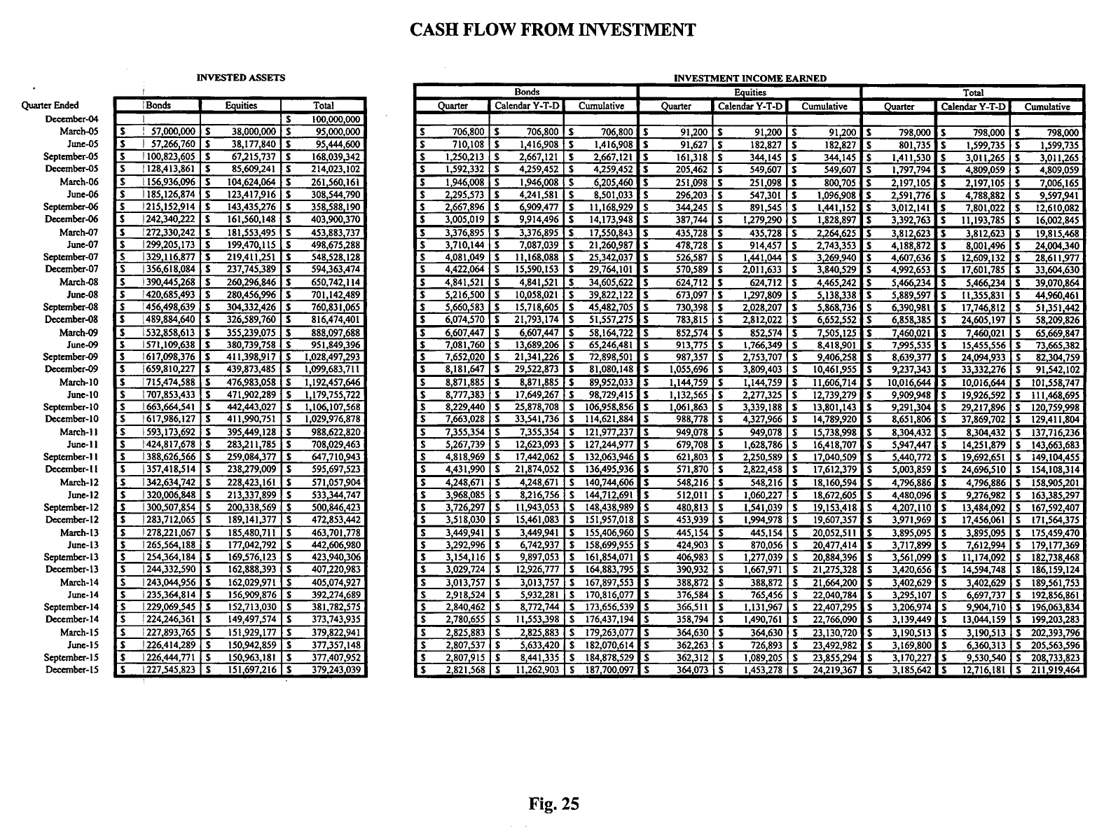

In addition to quarterly cash flows from operations are cash flows from investment. Knowledge of cash flows from operations is necessary for calculating investment cash flows because cash inflows from operations are added to the invested funds which produce investment income and realized capital gains. FIG. 25 is a table showing total invested assets at the beginning of each quarter. The assumptions described in FIG. 3 are that assets are allocated 60% in bonds and 40% in equities throughout the life of the SPC. The SPC raised $100 million in capital in 2004, paid $5,000,000 in startup costs, and began operations in 2005 with $95,000,000 in surplus funds. Based on the asset allocation referred to above, the opening balance for the SPC's first quarter of operations is $57,000,000 in bonds in $38,000,000 in equities.

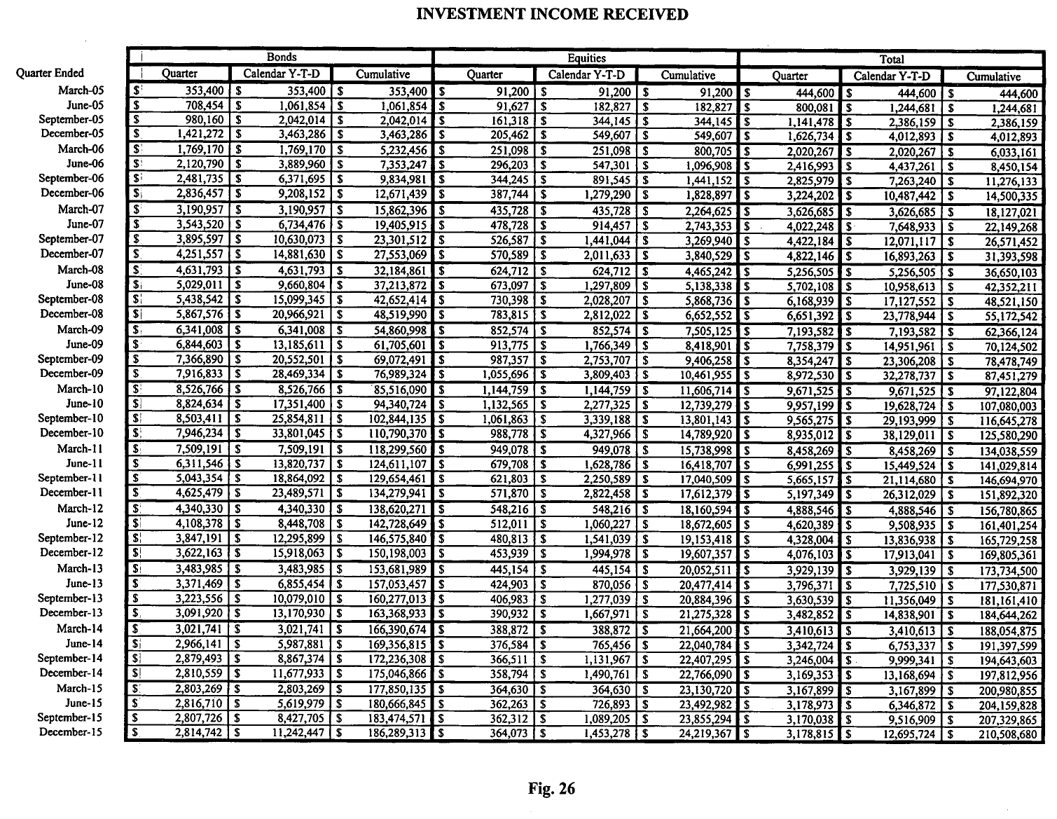

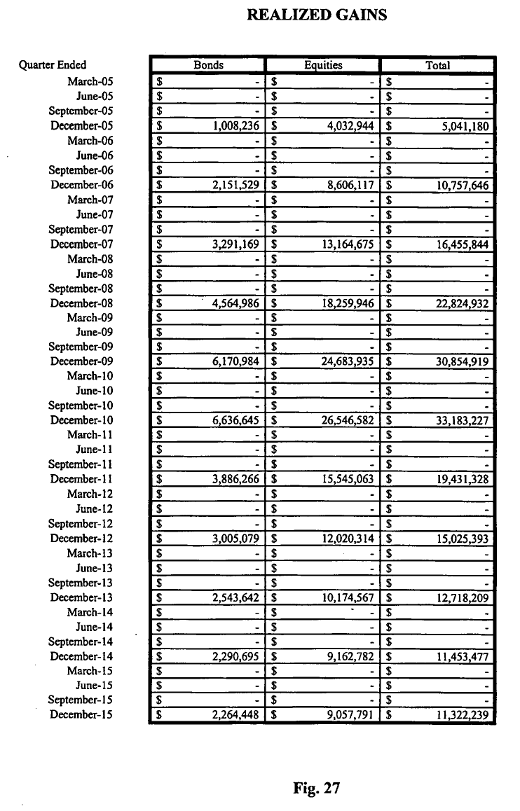

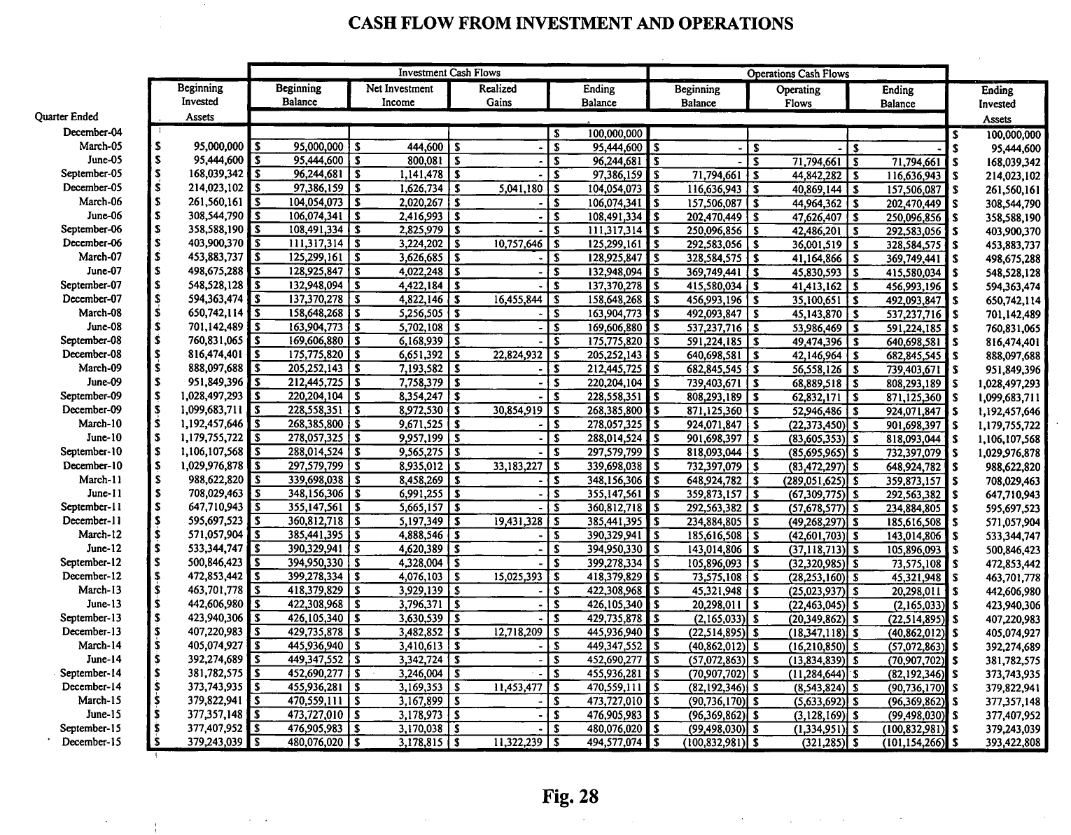

The model assumes 5% annual interest income from bonds and 1% annual dividend income from equities. Bonds are assumed to realize 1% capital gains per year and equities 6%. According to the model, investment income is received every quarter, while capital gains are realized only at the end of each calendar year. FIG. 26 is a table showing quarterly earned investment income. FIG. 27 is a table showing annual realized capital gains. Net investment income for the quarter ending March 2005, after one fourth of the 0.04% (40 basis points) annual investment advisory fee has been paid, is $706,800 from bonds, and $91,200 from equities, for a total of $798,000. The model assumes that one-half of the investment income earned in a quarter is received in the same quarter while the other half is received the next quarter. FIG. 28 presents quarterly investment income received. Since only one half of all investment income is received in the quarter it is earned, only $353,400 (one half of $706,800) of investment income is received in the first quarter of 2005 from bonds and $91,200 is received from equities. Total investment income receipts for the quarter ending March 2005 are $444,600. This amount is reinvested in bonds and equities respectively according to the assumed 60%/40% asset allocation rule. Thus, with these first quarter investment receipts the investment earnings for the second quarter of 2005 will be based not on the initial balances of $57,000,000 and $38,000,000, but rather on the increased balances of $57,266,760 and $38,177,840.

FIG. 28 is a table which combines quarterly cash flows from operations and from investment. Reference back to FIG. 25 shows that invested assets at the beginning of each quarter include the beginning balance from the previous quarter plus the previous quarter's investment cash flows plus the previous quarter's cash flows from underwriting operations. Thus, the opening balances for third quarter investments are $100,823,605 in bonds and 67,215,737 in equities for a total of $168,039,342, which is equal to the opening investment balance from the second quarter $95,444,600, as increased by the second quarter investment cash flows of $800,081, and underwriting operations cash flow of $71,794,661. At the end of the fourth quarter, the year's realized capital gains from both bonds and equity investments are also added to the total invested assets.

The information in the Tables in FIGS. 6 thru 28 is the input for the amounts on the Balance Sheet and Income Statement, shown in FIGS. 4 and 5. For example, the Income Statement shows that the total premium written in 2005 is $237,286,250. This value is derived from the table in FIG. 9, and represents the net premium written after 3% of gross premium written is set aside for funding the future purchase of reinsurance-to-close. The total premium earned for 2005 is $125,465,105. This is the annual total of net earned premium for 2005, which is found in the year-to-date entry for the fourth quarter of 2005 in the net earned premium table shown in FIG. 11. Investment income earned for 2005 is $4,259,452 from bonds and $549,607 from equities, for a total of $4,809,000. These numbers are derived from the Investment Income Earned table of FIG. 26. Premium and investment income earned in 2005 result in total income of $130,274,164.

On the expense side, from the net loss and LAE incurred table of FIG. 21 losses incurred for 2005 are $90,334,875. The ceding commission incurred table of FIG. 15 shows such expense of $56,263,750; the management fees incurred table of FIG. 16 shows such fees of $2,446,250; and the Federal excise tax incurred table of FIG. 17 shows such taxes of $2,446,250. FIG. 4 shows premium acquisition costs of $25,718,863, which are deferred from the first year. All of this results in total expenses of $125,772,262 for 2005. Subtracting total expenses from the total income leaves $4,501,902 of net operating income for 2005. Adding to this, the $5,041,180 in realized gains on investments in 2005 produces net income of $9,543,082 for the first year of operations.

The balance sheet (FIG. 4) shows that at the close of 2005, the SPC has total assets of $309,265,831. These include $21,190,641 of net premiums receivable, $796,166 in accrued investment income; and $25,718,863 in deferred acquisition costs. Liabilities at the end of 2005 include $111,821,145 in unearned premium; $84,462,041 in loss reserves; $7,338,750 set aside for the future purchase of reinsurance-to-close; and $1,100,834 of accrued expenses and startup costs, for total liabilities of $204,722,749. This results in net income for 2005 of $9,543,082, which increases shareholder equity from $95 million at the beginning of 2005 to $104,543,082 at the end of the year. Total liabilities and equity at the end of 2005 are $309,265,831.

Net income of $9,543,082 represents the only change in shareholder equity for 2005. No dividends are paid and no redemptions are made in 2005. Thus, shareholder equity increases that year from $95,000,000 to $104,543,082.

Based on the detailed description of the first year of operation of the model SPC, the financial projections through 2009 can be readily traced. The SPC operates in substantially the same manner from 2005 to 2009, investing surplus, writing premium, and paying losses and expenses. The only change in the SPC's operations is that as the end of 2009 approaches, the SPC will accept risk having a gradually shortened tail.

After 2009, however, the SPC stops underwriting and accepting premium. As can be seen on the Income Statement, no premium appears in 2010 and thereafter. There is some residual premium earned in 2010, ($312,982,903) based on premium written in 2009. After 2010, however, and no premium is written or earned, so that after 2010, all of the SPC's income is derived from invested funds. The SPC continues to pay losses on risk assumed in previous years.

In the present model, investors are given the option of cashing out of the SPC at the end of the fifth year (2009) by redeeming their shares or remaining shareholders in the SPC until 2015 when it is wound up. At both times, investors have the further option of a tax-free rollover of their investment into another SPC with similar operations.

In most instances, reinsurance-to-close will be purchased to discharge liability allocable to those shareholders redeeming shares and/or rolling over their investment at the end of the fifth year. Reinsurance-to-close may also be purchased prior to final distribution to shareholders and/or rollover of their equity at the end of the SPC's existence. At both times, the reinsurance-to-close will be purchased from the 3% setaside and if necessary from other funds of the SPC. FIG. 8 shows that the funds available for purchasing reinsurance-to-close and the discounted value of future earnings on loss reserves being transferred. Together these represent 22% of the loss reserves being reinsured and so should be sufficient to purchase the necessary reinsurance-to-close.

The present model assumes that the SPC's loss reserves will exactly cover the residual risk, both at the end of the underwriting phase and at the end of the runoff phase. In practice, it is almost certain that the loss reserves will either exceed the residual risk or will be insufficient. In both cases, an adjustment is necessary, either by crediting excess loss reserves to the SPC's surplus, or charging surplus for the shortfall.

The model assumes that 70% of the initial investors will opt to redeem or roll over their shares at the end of 5 years. Accordingly, the Balance Sheet (FIG. 4) shows a cash distribution of $212,367,219 paid in 2010, representing 70% of shareholder equity at the close of 2009. This assumes that 705 of the 3% setaside for reinsurance-to-close is sufficient to purchase that reinsurance. If it were not, the $212,367,219 distribution would be reduced by the shortfall. The investors who cash out the fifth year forgo any residual interest in the 3% setaside for purchasing reinsurance-to-close. Thus, they have no liability for the residual non-mature risk that the remaining investors in the SPC retain. Receipt of the $212,367,215 dividend ends their involvement with the SPC. This distribution for a five-year investment represents a 24.9% annual return on the investors' initial $70,000,000 investment.

The 30% of investors who are assumed to remain invested in the SPC after the fifth year benefit from the continuing investment income and capital gain earned both on the SPC's investment portfolio and on the remainder of the 3% setaside, as well as the premium earned in 2010. Thus, the remaining investors' equity continues to grow. After 2010, the SPC's income is limited to investment income and capital gains. Losses continue to be paid from the loss reserves which are effectively depleted in 2015 when all outstanding risk has either matured and losses paid out, or residual risk has been discharged by commutation of treaties and/or the purchase of reinsurance-to-close. If the cost of the reinsurance-to-close is greater or lesser than the 3% setaside, the remaining shareholders' final distribution will be correspondingly reduced or increased. Thus, in 2015 when all residual liability has been run out or is otherwise disposed of, shareholder equity stands at $394,833,592. This represents a 26.4% annual rate of return on the $30,000,000 invested by the 30% of investors who hold shares for the life of the SPC.

According to the model, investors enjoy very favorable returns whether they elect to cash out at the end of 5 years (24.9% annually) or whether they remain until the SPC is wound up (26.4% annually). See comparative investor return data in FIG. 29. Thus, a limited life SPC organized and operated as described provides an attractive vehicle for investment in underwriting insurance, reinsurance and retrocessional risk.

Another significant advantage of the present system is that SPCs may be used for numerous and varied purposes. The foregoing example shows an SPC may be organized to participate in property and casualty reinsurance directly with another reinsurer. In this model the SPC receives retrocessions from the reinsurer pursuant to an underwriting contract. Such participation on the part of the SPC may be on a whole account basis, or on selected lines. Similarly, an SPC may be established for property and casualty market reinsurance individually negotiated participations with, and retrocessions from, one or more reinsurers not under contract with the SPC. Such participations also may be on a whole account or selected lines basis. Participations need not be limited to property and casualty. SPCs may be created for life and health reinsurance participations with and retrocessions from reinsurers, either under contract or by an individual transaction negotiation, and on a whole account or selected lines basis. The same holds true for surety and guaranty reinsurance risks.

All the foregoing embodiments can be replicated to finance primary insurance risk—property and casualty, life and health, and surety and guaranty.

SPCs may be created for financing the purchase of a book of insurance or reinsurance business, or the acquisition of an insurance or reinsurance company. SPCs can finance finite risk reinsurance treaties. An SPC can assume highly volatile natural catastrophe risks such as hurricanes and earthquakes in lieu of catastrophe bond issues now offered in the capital market.

Finally, the SPC may utilize derivatives to transfer from the SPC all or substantially all underwriting risk and reward or investment risk and reward. The purpose of transferring investment risk would be to create a more highly leveraged security exclusively for underwriting risk which would have the potential for greater return associated with increased risk to investors. The use of derivatives to transfer underwriting risk from the SPC would have the opposite effect of reducing risk and potential return to investors.

These numerous alternative embodiments will produce returns to investors that likely could vary, perhaps substantially, from those projected by the model. As a general proposition, the greater the risk assumed, the greater the potential for high returns as well as loss.

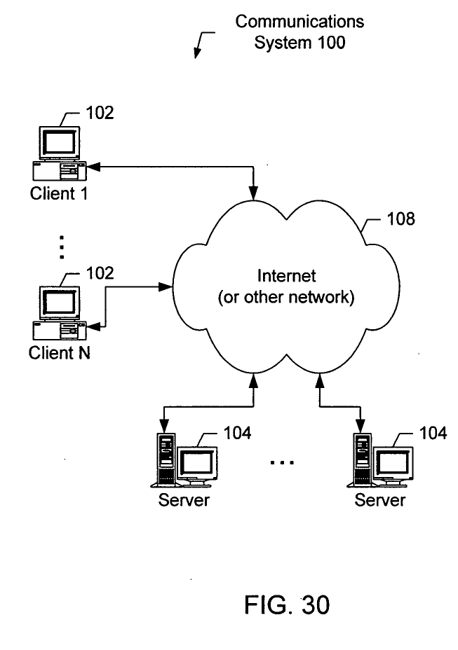

Computer Implemented Embodiments. Any of the above teachings may be implemented by a computing device in a networked environment. A high level block diagram of an exemplary network communications system 100 is illustrated in FIG. 30. The illustrated system 100 includes one or more client devices 102 and one or more servers 104. Each of these devices may communicate with each other via a connection to one or more communications channels 108 such as the Internet or some other data network, including, but not limited to, any suitable wide area network or local area network.

The server 104 stores a plurality of files, programs, and/or web pages in one or more databases 110 for use by the clients 102. The databases 110 may be connected directly to the server 104 and/or via one or more network connections. The databases 110 store information used by the server 104.

One server 104 may interact with a large number of clients 102. Accordingly, each server 104 is typically a high end computer with a large storage capacity, one or more fast microprocessors, and one or more high speed network connections. Conversely, relative to a typical server 104, each client device 102 typically includes less storage capacity, a single microprocessor, and a single network connection.

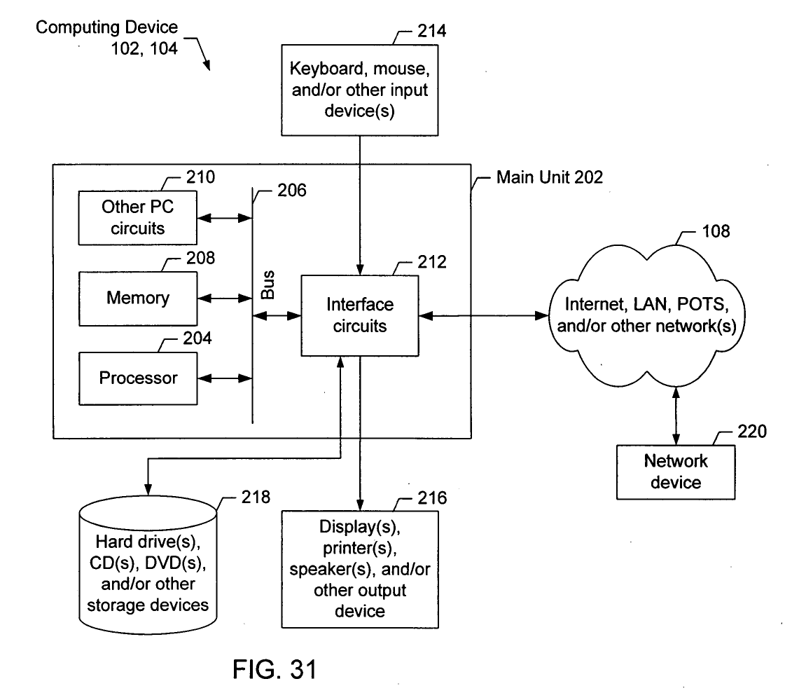

A more detailed block diagram of a client device 102 is illustrated in FIG. 31. The client device 102 may include a personal computer (PC), a personal digital assistant (PDA), an Internet appliance, a cellular telephone, or any other suitable communication device. The client device 102 includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with the other devices in the system 100. This program may be executed by the processor 204 in any suitable manner. The memory 208 may also store digital data indicative of documents, files, programs, web pages, etc. retrieved from a server 104 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the customer computer 102. For example, the display 216 may be used to display web pages received from the server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the customer computer 102.

The client device 102 may also exchange data with other network devices 220 via a connection to the network 108. The network connection may be any type of network connection, such as an Ethernet connection, digital subscriber line (DSL), telephone line, coaxial cable, etc. Users of the system 100 may be required to register with the server 104. In such an instance, each user may choose a user identifier (e.g., e-mail address) and a password which may be required for the activation of services. The user identifier and password may be passed across the network 108 using encryption built into the user's browser. Alternatively, the user identifier and/or password may be assigned by the server 104.

While various embodiments of the system have been described, it will be apparent to those of ordinary skill in the art that many more embodiments are possible within the scope of the system. Accordingly, the invention is not to be restricted except in light of the attached claims and their equivalents.

What is claimed is:

1. A method of securitizing risk comprising:
establishing a business entity with a predetermined period of existence, the predetermined period including an underwriting phase of a first predetermined duration followed by a runoff phase of a second predetermined duration;
raising capital through a sale of securities of the business entity;
actively underwriting and assuming a plurality of risks in exchange for premium during the underwriting phase, the plurality of risks including at least one of an insurance risk, a reinsurance risk, and a retrocessionary risk;
ending the active underwriting and assumption of risks at an end of the underwriting phase;
giving an investor a first option at the end of the underwriting phase, the first option including at least one option for (i) requiring a redemption by the business entity of shares in the business entity, (ii) rolling over equity in the business entity to a second business entity, and (iii) remaining invested in the business entity;
purchasing reinsurance-to-close to discharge risk of the business entity proportional to the shares being redeemed by the investor and to shares utilized to roll over equity in the business entity to the second business entity;
discharging risk during the runoff phase remaining after the purchase of reinsurance-to-close; and
ending the existence of the business entity at an end of the runoff phase.

2. The method of claim 1, wherein actively underwriting and assuming the plurality of risks comprises actively underwriting and assuming the plurality of risks at a plurality of times.

3. The method of claim 1, wherein the second business entity comprises a limited-life business entity embodying another underwriting phase of a third predetermined duration followed by another runoff phase of a fourth predetermined duration.

4. The method of claim 3, wherein rolling over equity in the business entity to the second business entity comprises a tax-free transfer of assets.

5. The method of claim 3, wherein the reinsurance-to-close proportionally allocable to redeemed shares is purchased from the second business entity.

6. The method of claim 3, wherein the reinsurance-to-close proportionally allocable to rolled over shares is purchased from the second business entity.

7. The method of claim 3, wherein the investor exercises the first option by redeeming a first portion of shares in the business entity and by rolling over a second portion of shares in the business entity to the second business entity.

8. The method of claim 1, further comprising making at least one interim cash distribution to the investor during the runoff phase.

9. The method of claim 3, further comprising giving an investor a second option at the end of the runoff phase, the second option including at least one option for (i) receiving a final distribution in liquidation of the business entity and (ii) rolling over equity in the business entity to a third limited life business entity that embodies yet another underwriting phase of a fifth predetermined duration followed by yet another runoff phase of a sixth predetermined duration.

10. The method of claim 9, wherein rolling over equity in the business entity to the third business entity comprises a tax-free transfer of assets.

11. The method of claim 9, further comprising discharging risk proportionally allocable to rolled over shares by purchasing reinsurance-to-close.

12. The method of claim 11, wherein the reinsurance-to-close proportionally allocable to rolled over shares is purchased from the second business entity.

13. The method of claim 9, wherein the investor exercises the second option by redeeming a first portion of shares in the business entity and by rolling over a second portion of shares in the business entity to the second business entity.

14. The method of claim 1, wherein ending the existence of the business entity comprises winding up the business entity by distributing assets of the business entity at an end of the business entity's predetermined period of existence.

15. The method of claim 1, wherein the business entity comprises a first business entity and the first business entity transfers assets to a second business entity in exchange for securities in the second business entity, the securities to be distributed to the shareholders of the first business entity.

16. The method of claim 15, wherein the first business entity further transfers liabilities to the second business entity.

17. The method of claim 1, wherein actively underwriting and assuming the plurality of risks during the underwriting phase comprises assuming progressively shorter tail risks during the underwriting phase.

18. The method of claim 1, wherein the underwriting phase does not assume only a single risk.

19. The method of claim 1, wherein the underwriting phase does not assume only a single package of risks.

20. The method of claim 1, wherein substantially all underwriting risk and associated opportunity for income are transferred by the business entity to a third party through the use of derivatives.

21. The method of claim 20, wherein all of the underwriting risk and associated opportunity for income are transferred by the business entity to the third party through the use of derivatives.

22. The method of claim 1, wherein substantially all investment risk and associated opportunity for income are transferred by the business entity to a third party through the use of derivatives.

23. The method of claim 22, wherein all of the investment risk and associated opportunity for income are transferred by the business entity to the third party through the use of derivatives.

24. The method of claim 1, further comprising establishing underwriting guidelines defining types and quality of risks the business entity is authorized to assume.

25. The method of claim 1, further comprising establishing requirements for diversification of risk by the business entity.

26. The method of claim 1, further comprising establishing a predefined premium to net worth ratio cap, wherein the business entity seeks to limit its written premium to the net worth ratio cap.

27. The method of claim 1, wherein the business entity seeks to limit its aggregate loss reserves to a predefined ratio to net worth.

28. The method of claim 1, further comprising investing capital raised by the sale of securities in the business entity and writing the premium based on the capital.

29. The method of claim 28, further comprising increasing a net worth of the business entity by reinvesting net underwriting income and net investment income and gain and writing additional premium based on the increased net worth.

30. The method of claim 1, wherein discharging remaining risk includes at least one of paying losses, commuting existing risk obligations, and purchasing reinsurance-to-close.

31. The method of claim 1, wherein raising capital comprises a sale of common shares in the business entity and at least one of preferred shares in the business entity, surplus notes, and other debt instruments.

32. The method of claim 1, wherein raising capital include a sale of derivatives.

33. The method of claim 1, wherein the business entity is a special purpose corporation.

34. The method of claim 33, wherein the special purpose corporation is an off-shore corporation.

35. A method of selling at least one of insurance, reinsurance, and retrocessional risk in capital markets comprising:
establishing a business entity with at least the following parameters being fixed at a time the business entity is established:
(i) an underwriting phase having a first predetermined duration during which the business entity actively underwrites and assumes a plurality of risks;
(ii) a runoff phase to occur after the underwriting phase, the runoff phase having a second predetermined duration during which the business entity discharges risks assumed during the underwriting phase and does not assume any additional risk; and
(iii) a first investor option to redeem shares in the business entity at an end of the underwriting phase, the redemption of shares being proportionally allocable to a discharge of risk by a reinsurance-to-close purchase; and
selling securities in the business entity.

36. The method of claim 35, wherein actively underwriting and assuming the plurality of risks comprises actively underwriting and assuming the plurality of risks at a plurality of times.

37. The method of claim 35, wherein the underwriting phase and the runoff phase define a predetermined overall limited life of the business entity.

38. The method of claim 35, further comprising a second investor option to roll over equity in the business entity to another business entity.

39. The method of claim 38, wherein the second investor option to roll over equity in the business entity to another business entity comprises a tax-free transfer of assets.

40. The method of claim 35, wherein the underwriting phase does not assume only a single risk.

41. The method of claim 35, wherein the underwriting phase does not assume only a single package of risks.

42. The method of claim 35, wherein substantially all underwriting risk and associated opportunity for income are transferred by the business entity to a third party through the use of derivatives.

43. The method of claim 42, wherein all of the underwriting risk and associated opportunity for income are transferred by the business entity to the third party through the use of derivatives.

44. The method of claim 35, wherein substantially all investment risk and associated opportunity for income are transferred by the business entity to a third party through the use of derivatives.

45. The method of claim 44, wherein all of the investment risk and associated opportunity for income are transferred by the business entity to the third party through the use of derivatives.

46. A method of investing in at least one of insurance, reinsurance and retrocessional risk by an investor comprising:
purchasing securities of a business entity established with
(i) an underwriting phase having a first predetermined duration during which the business entity actively underwrites and assumes a plurality of risks;
(ii) a runoff phase to occur after the underwriting phase, the runoff phase having a second predetermined duration during which the business entity discharges risks assumed during the underwriting phase and does not assume any additional risk; and
(iii) a first investor option to redeem shares in the business entity at an end of the underwriting phase, the redemption of shares being proportionally allocable to a discharge of risk by a reinsurance-to-close purchase; and exercising the investor option at the end of the underwriting phase.

47. The method of claim 46, wherein actively underwriting and assuming the plurality of risks comprises actively underwriting and assuming the plurality of risks at a plurality of times.

48. The method of claim 46, wherein the underwriting phase and the runoff phase define a predetermined overall limited life of the business entity.

49. The method of claim 46, further comprising a second investor option to roll over equity in the business entity to another business entity.

50. The method of claim 49, wherein the second investor option to roll over equity in the business entity to another business entity comprises a tax-free transfer of assets.

51. The method of claim 46, wherein the underwriting phase does not assume only a single risk.

52. The method of claim 46, wherein the underwriting phase does not assume only a single package of risks.

53. The method of claim 46, wherein substantially all underwriting risk and associated opportunity for income are transferred by the business entity to a third party through the use of derivatives.

54. The method of claim 53, wherein all of the underwriting risk and associated opportunity for income are transferred by the business entity to the third party through the use of derivatives.

55. The method of claim 46, wherein substantially all investment risk and associated opportunity for income are transferred by the business entity to a third party through the use of derivatives.

56. The method of claim 55, wherein all of the investment risk and associated opportunity for income are transferred by the business entity to the third party through the use of derivatives.

57. An apparatus comprising:
a controller;
an input/output device coupled to the controller; and
a memory coupled to the controller, the memory storing a software program for execution by the controller, the software program being structured to cooperate with the input/output device to facilitate:
establishing a business entity with a predetermined period of existence, the predetermined period including an underwriting phase of a first predetermined duration followed by a runoff phase of a second predetermined duration;
raising capital through a sale of securities of the business entity;
actively underwriting and assuming a plurality of risks in exchange for premium during the underwriting phase, the plurality of risks including at least one of an insurance risk, a reinsurance risk, and a retrocessionary risk;
ending the active underwriting and assumption of risks at an end of the underwriting phase;
giving an investor a first option at the end of the underwriting phase, the first option including at least one option for (i) requiring a redemption by the business entity of shares in the business entity, (ii) rolling over equity in the business entity to a second business entity, and (iii) remaining invested in the business entity;
purchasing reinsurance-to-close to discharge risk of the business entity proportional to the shares being redeemed by the investor and to shares utilized to roll over equity in the business entity to the second business entity;
discharging risk remaining after the purchase of reinsurance-to-close during the runoff phase; and
ending the existence of the business entity at an end of the runoff phase.

58. The apparatus of claim 57, wherein actively underwriting and assuming the plurality of risks comprises actively underwriting and assuming the plurality of risks at a plurality of times.

59. The apparatus of claim 57, wherein rolling over equity in the business entity to the second business entity comprises a tax-free transfer of assets.

60. The apparatus of claim 57, wherein the software program is further structured to facilitate giving an investor a second option at the end of the runoff phase, the second option including at least one option for (i) receiving a final distribution in liquidation of the business entity and (ii) rolling over equity in the business entity to the second business entity.

61. The apparatus of claim 57, wherein the underwriting phase does not assume only a single risk.

62. The apparatus of claim 57, wherein the underwriting phase does not assume only a single package of risks.

63. The apparatus of claim 57, wherein the software program is further structured to facilitate the transfer of substantially all underwriting risk and associated opportunity for income by the business entity to a third party through the use of derivatives.

64. The apparatus of claim 63, wherein all of the underwriting risk and associated opportunity for income are transferred by the business entity to the third party through the use of derivatives.

65. The apparatus of claim 57, wherein the software program is further structured to facilitate the transfer of substantially all investment risk and associated opportunity for income by the business entity to a third party through the use of derivatives.

66. The apparatus of claim 65, wherein all of the investment risk and associated opportunity for income are transferred by the business entity to the third party through the use of derivatives.

67. The apparatus of claim 57, wherein the software program is further structured to facilitate a conformance to underwriting guidelines and promote a diversification of risks.

68. The apparatus of claim 67, wherein the software program is further structured to facilitate an analysis of premium trends and lost trends.
